(19) United States
(12) Patent Application Publication
(10) Pub. No.: US 2007/0190513 A1
(43) Pub. Date: Aug. 16, 2007

(54) Learning system, learning server, and program

(75) Inventor: Mamoru Ito, Tokyo (JP)

Correspondence Address: BACON & THOMAS, PLLC, 625 SLATERS LANE, FOURTH FLOOR, ALEXANDRIA, VA, 22314, US

(73) Assignee: Coach 21 co.,LTD, Tokyo (JP)

(21) Appl. No.: 10/591,278

(22) PCT Filed: Mar. 3, 2005
(86) PCT No.: PCT/JP05/03585

§ 371 Date: Aug. 31, 2006

(30) Foreign Application Priority Data
Mar. 4, 2004 (JP) 2004-061149
Nov. 2, 2004 (JP) 2004-319420

(51) Int. Cl. G09B 3/00

(52) U.S. Cl. 434/350

(57) ABSTRACT

To provide a learning system which can supply a high-quality learning information to a student, a learning system (10) connects a terminal device (41A) for a student having an operating portion (45) and a display portion (44) displaying an image visible by the student, to a terminal device (41B) for instructor having a display portion (44) displaying an image visible by an instructor, so as to freely communicate, and transmits and receives learning information relating to a learning between them, the terminal device (41A) for student sequentially collects learning operation information on the basis of operation of the operating portion (45) with respect to question information relating to the learning displayed on the display portion (44) so as to transmit, and an image relating to the learning operation information is sequentially displayed on the display portion (44).

This is a nationalization of PCT/JP2005/003585 filed Mar. 3, 2005, and published in Japanese.

### BACKGROUND OF THE INVENTION

1. Field of the Invention

The present invention relates to a learning system, a learning server and a learning program for controlling information relating to learning.

2. Description of the Conventional Art

Conventionally, in learning systems, there has been known a learning system sending and receiving learning information relating to a learning to and from a student who take a course, and there exist a lot of systems which are connected to a terminal device of the student so as to freely communicate and supply the learning information to the terminal device, among them.

Among them, in accordance with a remarkable progress of information technology in recent years, there has been well known a learning system for learning via a network such as an internet called as an e-learning. For example, in Japanese Unexamined Patent Publication No. 2002-156894, there is provided a remote education method and system, in which computers for a lecturer and a student are connected via an internet network, an oral presentation of the lecturer, an image of the lecturer's face and a board written information handwritten and input by the lecturer are out put to the computer for the student, and education can be done similarly to the case that the lecturer and the student get together in a classroom, even in the case that the lecturer and the student stay at remote places each other.

### SUMMARY OF THE INVENTION

### Problem to be Solved by the Invention

However, in the learning system mentioned above, such the two-way remote communication method has an advantage that learning can be done at the remote places where a lecturer and a student stay away from each other, however, on the contrary, it is hard to say that such is under a learning environment that the lecturer can know in detail and sufficiently how the student carries on the learning.

For example, in the case that question information for a test or the like relating to the learning is transmitted to a student from the terminal device of an instructor, and an answer to the question information is transmitted to the instructor from the terminal device of the student, the instructor can only receive the result as the answer to the test, it is impossible to make the instructor recognize a process for deriving the answer, and there is a risk of harming the learning system providing a simple and convenient learning via the network.

The present invention is made by taking the problem mentioned above into consideration, and an object of the present invention is to provide a learning system which can supply high-quality learning information to a student by removing an adverse effect caused by using a terminal device transmitting and receiving only mere answer results.

### Means for Solving the Problem

(1) A learning system connecting a student terminal having an operating portion capable of being operated by a student, a display portion on which an image visible by the student is displayed, and a display control means for displaying the image on the display portion, to an instructor terminal having a display portion displaying an image visible by an instructor, and a display control means for displaying an image on the display portion, so as to freely communicate, and transmitting and receiving learning information relating to a learning between the student terminal and the instructor terminal, wherein the student terminal has a learning operation information collecting means for sequentially collecting learning operation information on the basis of operation of the operating portion in correspondence to the learning information displayed on the display portion of the student terminal, and a transmitting means for sequentially transmitting the learning operation information to the instructor terminal, and the display control means in the instructor terminal has a function of sequentially displaying the image relating to the learning operation information on the display portion of the instructor terminal.

(2) A learning system connecting a student terminal having an operating portion capable of being operated by a student, a display portion on which an image visible by the student is displayed, and a display control means for displaying the image on the display portion, to an instructor terminal having a display portion displaying an image visible by an instructor, a display control means for displaying an image on the display portion, and a voice generating means for generating a voice, so as to freely communicate, and transmitting and receiving learning information relating to a learning between the student terminal and the instructor terminal, wherein the student terminal has a learning operation information collecting means for sequentially collecting learning operation information on the basis of operation of the operating portion in correspondence to the learning information displayed on the display portion of the student terminal, a photographing means for sequentially photographing face information of the student, a voice collecting means for sequentially collecting voice information generated by the student, and a transmitting means for sequentially transmitting the face information, the learning operation information and the voice information to the instructor terminal, the display control means in the instructor terminal has a function of sequentially displaying the image relating to the face information and the learning operation information on the display portion of the instructor terminal, and the voice generating means in the instructor terminal has a function of generating the voice information.

(3) A learning system connecting an instructor terminal having an operating portion capable of being operated by an instructor, a display portion on which an image visible by the instructor is displayed, and a display control means for displaying an image on the display portion, to a student terminal having a display portion displaying an image visible by a student, and a display control means for displaying the image on the display portion, so as to freely communicate, and transmitting and receiving learning information relating to a learning between the student terminal and the instructor terminal, wherein the instructor terminal has an instructor operation information collecting means for sequentially collecting instructor operation information on the basis of operation of the operating portion, and a transmitting means for sequentially transmitting the instructor operation information to the student terminal, and the display control means in the student terminal has a function of sequentially displaying the image relating to the instructor operation information on the display portion of the student terminal.

(4) A learning system connecting a student terminal having an operating portion capable of being operated by a student, a display portion on which an image visible by the student is displayed, and a display control means for displaying the image on the display portion, to an instructor terminal having a display portion displaying an image visible by an instructor, and a display control means for displaying an image on the display portion, so as to freely communicate, and transmitting and receiving learning information relating to a learning between the student terminal and the instructor terminal, wherein the instructor terminal and another of the student terminal has a learning operation information collecting means for sequentially collecting learning operation information on the basis of an operation of the operating portion of one of the student terminal, and a transmitting means for sequentially transmitting the learning operation information to the instructor terminal and the other of the student terminal, and the display control means in the other student terminal and the instructor terminal have a function of sequentially displaying the image relating to the learning operation information on the display portions of the other student terminal and the instructor terminal.

(5) A learning system connecting an instructor terminal having an operating portion capable of being operated by an instructor, a display portion on which an image visible by the instructor is displayed, and a display control means for displaying an image on the display portion, to a student terminal having an operating portion capable of being operated by a student, a display portion displaying an image visible by the student, and a display control means for displaying the image on the display portion, so as to freely communicate, and transmitting and receiving learning information relating to a learning between the student terminal and the instructor terminal, wherein the student terminal has a learning operation information collecting means for sequentially collecting learning operation information on the basis of operation of the operating portion in correspondence to the learning information displayed on the display portion of the student terminal, and a transmitting means for sequentially transmitting the learning operation information to the instructor terminal, the display control means in the instructor terminal has a function of sequentially displaying the image relating to the learning operation information on the display portion of the instructor terminal, the instructor terminal has an instructor operation information collecting means for sequentially collecting an instructor operation information on the basis of operation of the operating portion, and a transmitting means for sequentially transmitting the instructor operation information to the student terminal, and the display control means in the student terminal has a function of sequentially displaying the image relating to the instructor operation information on the display portion of the student terminal.

(6) In the learning system as described in any one of the items (1) to (5), the instructor terminal has a transmitting means for transmitting question information relating to the learning to the student terminal, and the learning operation information collecting means in the student terminal has a function of sequentially collecting the learning operation information on the basis of the operation of the operating portion in correspondence to the question information displayed on the display portion of the student terminal.

(7) In the learning system as described in any one of the items (1) to (6), the learning operation information collecting means in the student terminal has a function of sequentially collecting at least one of character information, positional information of a pointer, decision information and cancellation information included in the learning operation information on the basis of the operation of the operating portion in correspondence to the learning information displayed on the display portion of the student terminal.

(8) In the learning system as described in any one of the items (1) to (7), the instructor terminal has a learning memory means for storing at least one of the learning operation information, the face information and the voice information transmitted from the transmitting means in the student terminal.

(9) In the learning system as described in any one of the items (1) to (8), the student terminal has a selecting means for selecting whether making the function of transmitting the learning operation information by the transmitting means effective or ineffective.

(10) A learning server connected to a student terminal having an operating portion capable of being operated by a student, and a display portion on which an image visible by the student is displayed and an instructor terminal having a display portion on which an image visible by an instructor is displayed, so as to freely communicate, and transmitting and receiving learning information relating to a learning with respect to the student terminal and the instructor terminal, wherein the learning server has a transmitting means for sequentially transmitting a signal for sequentially displaying an image relating to learning operation information on the basis of operation of the operating portion on the display portion of the instructor terminal to the instructor terminal, in correspondence to the learning information sequentially transmitted from the student terminal and displayed on the display portion of the student terminal.

(11) In the learning server as described in the item (10), the transmitting means has a function of transmitting the question information to the student terminal in correspondence to a question request signal from the instructor terminal, and has a function of sequentially transmitting a signal for sequentially displaying an image relating to the learning operation information on the basis of the operation of the operating portion on the display portion of the instructor terminal, to the instructor terminal, in correspondence to the question information sequentially transmitted from the student terminal and displayed on the display portion of the student terminal.

(12) In the learning server as described in the item (10), the learning server has a transmitting means for sequentially transmitting a signal for sequentially displaying an image relating to at least one of character information, positional information of a pointer, decision information and cancellation information included in the learning operation information on the basis of the operation of the operating portion on the display portion of the instructor terminal, to the instructor terminal, in correspondence to the learning information sequentially transmitted from the student terminal and displayed on the display portion of the student terminal.

(13) In the learning server as described in any one of the items (10) to (12), the learning server has a learning memory means for storing the learning operation information sequentially transmitted from the student terminal.

(14) In the learning server as described in any one of the items (10) to (13), the learning server has a billing means for billing with respect to the student terminal and/or the instructor terminal, in the case that the function in the transmitting means is made effective.

(15) A program for making a student terminal having an operating portion capable of being operated by a student and a display portion on which an image visible by the student is displayed, function as a display step of displaying learning information relating to a learning on the display portion, a collecting step of sequentially collecting learning operation information on the basis of operation of the operating portion, in correspondence to the learning information displayed on the display portion in accordance with the display step, and a transmitting step of sequentially transmitting a signal for displaying the learning operation information sequentially collected in accordance with the collecting step on a display portion in an instructor terminal connected so as to freely communicate, to the instructor terminal.

(16) A program for making a student terminal having an operating portion capable of being operated by an instructor and a display portion on which an image visible by the instructor is displayed, function as a display step of displaying instruction information relating to an instruction on the display portion, a collecting step of sequentially collecting instruction operation information on the basis of operation of the operating portion, in correspondence to the instruction information displayed on the display portion in accordance with the display step, and a transmitting step of sequentially transmitting a signal for displaying the instruction operation information sequentially collected in accordance with the collecting step on a display portion in a student terminal connected so as to freely communicate, to the student terminal.

(17) A program for making a student terminal having an operating portion capable of being operated by a student and a display portion on which an image visible by the student is displayed, function as a display step of displaying learning information relating to a learning on the display portion, a collecting step of sequentially collecting learning operation information on the basis of operation of the operating portion, in correspondence to the learning information displayed on the display portion in accordance with the display step, and a transmitting step of sequentially transmitting a signal for displaying the learning operation information sequentially collected in accordance with the collecting step on a display portion in another student terminal and an instructor terminal connected so as to freely communicate, to the other student terminal and the instructor terminal.

In accordance with the invention described in the items (1), (2), (10) and (15), since the structure is made such as to collect and transmit the learning operation information on the basis of the operation of the operating portion in correspondence to the learning information displayed on the display portion of the student terminal sequentially (in real time), and sequentially display the image relating to the learning operation information on the basis of the operation on the display portion of the instructor terminal, the learning condition such as the response to the learning information of the student is displayed in detail and sequentially to the instructor, and it is possible to supply a useful information capable of providing a high-quality learning information to the student.

Of course, a retention of the student utilizing the present system, the present server and the present program is increased by providing the useful information capable of providing the high-quality learning information to the student.

In this case, “learning” simply allows the student to learn, is not limited to learning in schools such as a school, a preparatory school, a professional school and the like, but corresponds to various aspects, for example, a self-education in a company, an audio conferencing and the like.

Particularly, since the present system is structured such that the student terminal and the instructor terminal are connected so as to freely communicate “via a general communication line”, it is possible to supply a useful information capable of comprehending the learning condition in detail and sequentially, by displaying the response of the learning information or the like of the student to the instructor, even in the case that the student and the instructor stay at remote places.

In this case, the “general communication line” means a generally used communication line such as an internet or the like, and corresponds to a concept of connecting both the terminals so as to freely communicate with each other even if the student and the instructor stay at the remote places.

Further, it is possible to supply a learning environment taking an environment into consideration without using any unnecessary paper medium such as a test paper, a check list or the like. Of course, it is possible to mutually supply information between both the terminals, and a simple and convenient structure is achieved.

Further, the learning operation information corresponds to a concept including not only the result in the case that the operating portion is operated by the student, but also the result in the case that the operating portion is not operated by the student, and includes, for example, the case that the pointer of the mouse stops at a predetermined position.

Further, in accordance with the invention described in the item (2) mentioned above, since the structure is made such as to sequentially collect and transmit the face information of the student and the voice information generated by the student, sequentially display the image relating to the transmitted face information on the display portion of the instructor terminal, and generate the transmitted voice information by the voice generating means of the instructor terminal, it is possible to display as an image and generate as a voice the learning condition such as a facial expression, a voice tone and the like of the student in detail and sequentially to the instructor, whereby it is possible to further supply a useful information capable of providing the high-quality learning information to the student.

Further, the structure may be made such that “the display control means in the instructor terminal has a function of displaying the face information and the learning operation information in parallel (simultaneously) on the display portions”. Of course, the structure may be made such that “the voice generating means in the instructor has a function of generating a voice information in parallel to displaying the face information and the learning operation information on the display portion by the display control means in the instructor terminal”, whereby it is possible to supply a useful information to the instructor staying at a distance.

Further, the structure may be made such that “the instructor terminal has a photographing means for sequentially photographing a face information of the instructor, a voice collecting means for sequentially collecting a voice information generated by the instructor, and a transmitting means for transmitting the face information sequentially photographed by the photographing means and the voice information sequentially collected by the voice collecting means to the student terminal”, and the structure may be made such that “the student terminal has a display control means for sequentially displaying the face information transmitted by the transmitting means in the instructor terminal on the display portion, and a voice generating means generating a voice information transmitted by the transmitting means in the instructor terminal”.

In accordance with the structure mentioned above, it is possible to display as a image and generate as a voice the learning condition such as the facial expression, the voice tone or the like of the instructor in detail and sequentially to the student, and it is possible to further supply the useful information capable of providing the high-quality learning information and learning environment to the student.

In this case, the transmitting means of the student terminal and the instructor terminal may be separately structured such as a first transmitting means for transmitting the face image, a second transmitting means for transmitting the voice information, and a third transmitting means for transmitting the learning information. Of course, the transmitting means of the instructor terminal may be separately structured such as a first transmitting means for transmitting the face information, a second transmitting means for transmitting the voice information, and a third transmitting means for transmitting the question information.

In accordance with the invention described in the item (6) or (11), since the structure is made such that the question information is transmitted, and the learning operation information in response to the question information is displayed on the display portion of the instructor terminal, it is possible to transmit the information making the response or the like of the learning of the student corresponding to the learning operation information in response to the question information more definite to the student terminal, and the learning operation information is displayed on the display portion of the instructor terminal. Therefore, it is possible to further supply the useful information capable of providing the high-quality learning information to the student.

In accordance with the invention described in the item (7) or (12), since the character information, the pointer positional information, the decision information and the cancellation information operated by the student are transmitted to the instructor terminal, it is further possible to in detail and sequentially display the learning condition such as the response to the learning information of the student or the like to the instructor, and it is possible to supply the useful information capable of providing the high-quality learning information to the student.

Further, the structure may be made such that “the pointer positional information is constituted by a positional information corresponding to the image relating to the learning information displayed on the display portion in the student terminal”. In this case, since only the positional information is transmitted without transmitting the image information, it is possible to prevent a fault due to a communication delay. Of course, the structure may be made such that “the pointer positional information is transmitted by the transmitting means in the instructor terminal, and corresponds to a positional information corresponding to an image relating a question information displayed on the display portion in the student terminal”. In this case, it is possible to supply the useful learning information to the student.

In this case, the “pointer positional information” is based on the operation of the operating portion, and corresponds, for example, to various aspects such as a pointer used for operating a mouse, a pointer used for operating a keyboard and the like.

Further, the pointer information transmitted by the transmitting means in the student terminal is displayed as a pointer information image on the display portion by the display means in the instructor terminal, however, may have “a determining means for determining a display aspect of the pointer information image”, whereby even in the case that the image is displayed small, it is possible to easily view the pointer information image. For example, it includes a function of determining a display color of the pointer information image, or flashing the display of the pointer information image.

In accordance with the invention described in the item (8) or (13), since the structure is made such as to store the sequentially displayed learning information, the sequentially displayed face image, the sequentially generated voice information and the like, it is possible to again output the learning information, the face image and the voice to the instructor, so that the learning condition such as the response to the learning information of the student is further displayed (generated) in detail, and it is possible to supply the useful information capable of providing the high-quality learning information to the student.

Of course, the structure may be made such that “the student terminal has a memory means for storing at least one of the learning information, the face information and the voice information transmitted by the transmitting means in the student terminal”. Since the structure is made such as to store the sequentially displayed learning information, the sequentially displayed face image, the sequentially generated voice and the like, it is possible to again output the learning information, the face image, the voice and the like to the student, so that the learning condition such as the response to the learning information of the student is further displayed in detail and sequentially, and it is possible to supply the useful learning information to the student itself.

Further, the structure may be made such that “the instructor terminal has a memory means for storing at least one of the question information, the face information and the voice information transmitted by the transmitting means in the instructor terminal”. Since the structure is made such as to store the sequentially displayed question information, the sequentially displayed face image, the sequentially generated voice and the like, it is possible to again output the question information, the face image, the voice and the like to the instructor, so that it is possible to display the learning information and the learning environment such as the learning information of the instructor to the student, the aspect of the instruction and the like in detail and sequentially, it is possible to supply the useful learning information to the instructor itself, and it is possible to indirectly supply the useful learning information to the student.

Of course, the structure may be made such that “the student terminal has a memory means for storing at least one of the question information, the face information and the voice information transmitted by the transmitting means in the instructor terminal”. Since the structure is made such as to store the sequentially displayed question information, the sequentially displayed face image, the sequentially generated voice and the like, it is possible to again output the question information, the face image, the voice and the like to the student, so that it is possible to display the learning information and the learning environment such as the learning information of the instructor to the student, the aspect of the instruction and the like in detail and sequentially, and it is possible to supply the useful information capable of providing the high-quality learning information to the student.

Further, in accordance with the invention described in the item (13), the structure may be made such that “the learning server has a function of displaying (generating) at least one of the learning information, the face information and the voice information stored in the memory means in the learning server in correspondence to the operation of the instructor terminal and/or the student terminal”.

Further, the structure may be made such that “the memory means has a function of storing a result and a process of the learning operation information”.

Further, the structure may be made such that “the question information is constituted by a plurality of question items, the plurality of question items are displayed on the display portion of the student terminal all at once, and the memory means has a function of storing an answer order in response to the plurality of question items”. Accordingly, it is possible to output only the answer order corresponding to an important factor without outputting all the stored information, and a simple and convenient structure is achieved. Of course, it is possible to output the answer contents and a simple and convenient structure is achieved.

Further, the structure may be made such that “the question information is constituted by one question item, the one question item is sequentially displayed on the display portion of the student terminal, and the memory means has a function of storing an answer time in response to the one question item”. Accordingly, it is possible to output only the answer time corresponding to an important factor without outputting all the stored information, and a simple and convenient structure is achieved. Of course, it is possible to output the answer contents and a simple and convenient structure is achieved.

In accordance with the invention described in the item (9), it is possible to determine whether effective or ineffective the various transmitting functions are, by the student, it is possible to supply the learning environment desired by the student, and a simple and convenient structure is achieved. Of course, the structure may be made such that “the instructor terminal has a selecting means for selecting whether making the function of transmitting the learning operation information by the transmitting means effective or ineffective, on the basis of the operation of the operating portion”, and the student terminal and the instructor terminal may be combined.

In accordance with the invention described in the item (14), since the structure is made such that the billing is carried out by making the function such as the transmitting means in the learning server effective, it is possible to achieve the billing to the instructor and the student using the learning server, and it is useful for a manager of the learning server.

In accordance with the invention described in the item (15), it is possible to provide the learning system in which the display control means in the student terminal has a function of sequentially displaying an image relating to the instructor operation information on the display portion of the student terminal.

### Effect of the Invention

In accordance with the present invention, since the structure is made such as to sequentially collect and transmit the learning operation information on the basis of the operation of the operating portion in correspondence to the learning information displayed on the display portion of the student terminal, and sequentially display the image relating to the learning operation information on the display portion of the instructor terminal, it is possible to display the learning condition such as the response to the learning information of the student and the like in detail and sequentially to the instructor, and it is possible to supply the useful information capable of providing the high-quality learning information to the student.

### BRIEF EXPLANATION OF DRAWINGS

FIG. 1 is a schematic view showing a structure of a learning system in an embodiment in accordance with the present invention;

FIG. 2 is a schematic view showing an electric structure of a learning server in an embodiment in accordance with the present invention;

FIG. 3 is an explanatory view showing a database of a learning server in an embodiment in accordance with the present invention;

FIG. 4 is an explanatory view showing a database of a learning server in an embodiment in accordance with the present invention;

FIG. 5 is an explanatory view showing a database of a learning server in an embodiment in accordance with the present invention;

FIG. 6 is an explanatory view showing a database of a learning server in an embodiment in accordance with the present invention;

FIG. 7 is an explanatory view showing a database of a learning server in an embodiment in accordance with the present invention;

FIG. 8 is an explanatory view showing an electric structure of a terminal device in an embodiment in accordance with the present invention;

FIG. 9 is an explanatory view showing an image formed on a display portion of a terminal device in an embodiment in accordance with the present invention;

FIG. 10 is an explanatory view relating a learning operation information of a terminal device in an embodiment in accordance with the present invention;

FIG. 11 is a flow chart of a learning system in an embodiment in accordance with the present invention;

FIG. 12 is a flow chart of a learning system in an embodiment in accordance with the present invention;

FIG. 13 is a flow chart of a learning system in an embodiment in accordance with the present invention;

FIG. 14 is a flow chart of a learning system in an embodiment in accordance with the present invention;

FIG. 15 is a schematic view showing a structure of a learning system in an embodiment in accordance with the present invention;

FIG. 16 is a schematic view showing a structure of a learning system in an embodiment in accordance with the present invention;

FIG. 17 is a view showing an outline of a processing procedure of each of terminals in a real time learning system;

FIG. 18 is a view showing an event processing procedure (an instructor terminal) in accordance with a 1-way method;

FIG. 19 is a view showing an event processing procedure (a student terminal) in accordance with a 1-way method;

FIG. 20 is a view showing an event processing procedure (an instructor terminal) in accordance with a 2-way method;

FIG. 21 is a view showing an event processing procedure (a student terminal) in accordance with a 2-way method;

FIG. 22 is a view showing an event processing procedure (an instructor terminal) in accordance with an n-way method; and

FIG. 23 is a view showing an event processing procedure (a student terminal) in accordance with an n-way method.

### DETAILED DESCRIPTION OF PREFERRED EMBODIMENT

A description will be given below of a preferable embodiment in accordance with the present invention with reference to the accompanying drawings.

[System Structure]

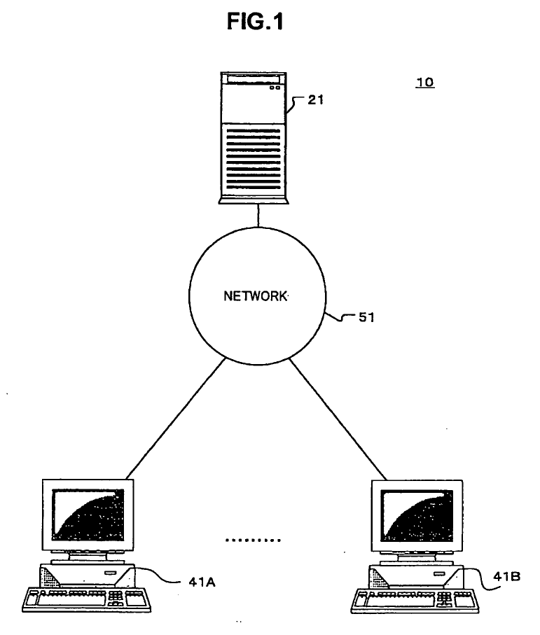

FIG. 1 is a schematic view showing a learning system in the present embodiment.

In a learning system 10 shown in FIG. 1, a learning server 21 controlling various information relating to a learning and provided in a terminal device 41A can be connected to a network 51 constituted by an internet, a dedicated line, a provider, a voice communication station, a base station for cellular phones, a satellite communication station and the like, and can be communicated via the network 51.

In this case, only the learning server 21 is shown as a server connected to the network 51 in FIG. 1, however, the server is not limited to this, but can be constituted by a plurality of servers by dividing a function of the learning server 21 mentioned below. Further, the structure may be made such that a plurality of learning servers 21 are provided, and an external server entirely managing the learning servers 21 is provided, and a simple and convenient structure can be achieved.

Further, a plurality of terminal devices 41A, 41B, . . . can be connected to the network 51, and it is possible to access to the learning server 21 from a plurality of terminal devices 41A, 41B, . . . .

In this case, each of the terminal devices 41A, 41B, . . . in the present embodiment employs a personal computer 41A, however, is not limited to this, but can employ a terminal device by which a user can access to the network 51. The terminal device which can be accessed to the network 51 includes communicable terminal devices, for example, a notebook type personal computer, a mobile computer, a cellular phone, a personal digital assistant (PDA) and the like, in addition to the personal computer 41A.

Further, as an accessing method, a dialogue of packet generated in TCP/IP protocol group between each of the terminal devices 41A, 41B, . . . and the network 51 (a host computer of a provider) such as the internet or the like is executed by utilizing a dial-up point-to-point protocol (PPP) connection, and a communication in accordance with the TCP/IP protocol is executed in the network 51 (between the host computer of the provider and the learning server 21).

In this case, the structure is made such as to be communicable with the learning server 21 via the network 51 by using a terminal device of a wired system such as the personal computer in the present embodiment, however, the structure is not limited to this, but a wired system or a wireless system may be employed as far as it is possible to communicate.

For example, the structure may be made such as to be communicable with the learning server 21 via the network 51 by connecting a terminal device having a portability to an apparatus of the wired system. In this case, there is mainly employed a structure supplying a voice data by utilizing a radio wave of a digital form, such as a time division multiple access (TDMA) method, a code division multiple access (CDMA) method and the like. These radio waves are connected to the learning server 21 via base stations scattered about various locations. Accordingly, the terminal devices 41A, 41B, . . . can get various supplied information from the learning server 21, and it is possible to supply various information to the learning server 21.

Further, in the present embodiment, the structure is made such that the terminal devices 41A, 41B, . . . are indirectly connected to the network 51 by connecting the terminal devices 41A, 41B, . . . to the learning server 21, however, the structure is not limited to this, but the terminal devices 41A, 41B, . . . may be directly connected to the network 51.

Further, in the present embodiment, the learning server 21 is connected to the terminal devices 41A, 41B, . . . so as to be directly communicable via the network 51, however, the structure is not limited to this, but the learning server 21 may be communicably connected to a plurality of terminal devices such. as the terminal devices 41A, 41B and the like. For example, the structure may be made such that the learning server 21 is indirectly communicably connected to the terminal devices 41A, 41B and the like, whereby the learning server 21 is communicably connected to the terminal device 41A via the network 51, and is not directly connected to the terminal device 41B, and the terminal device 41A and the terminal device 41B are communicably connected.

Further, since the present system is structured in such a manner as to communicably connect the terminal device 41A serving as a student terminal and the terminal device 41B serving as an instructor terminal “via a general communication line”, it is possible to supply a useful information capable of comprehending a learning condition in detail and sequentially by displaying a response of a learning information of the student or the like to the instructor, even in the case that the student and the instructor stay at remote places.

In this case, the “general communication line” corresponds to a communication line generally used for an internet or the like, and means a concept of connecting both the terminals so as to be communicable with each other even if the student and the instructor stay at the remote places.

Further, the present embodiment is constituted by the learning server 21, the network 51 and the terminal devices 41A, 41B, . . . , however, the structure is not limited to this, but may be provided with the other devices.

[Server Structure]

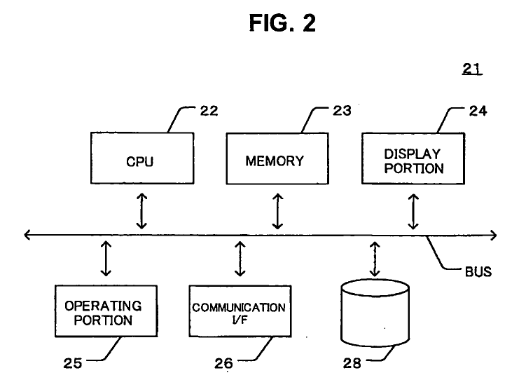

FIG. 2 is a block diagram showing a control circuit of the learning server in accordance with the present embodiment.

As shown in FIG. 2, in the learning server 21, a CPU 22 serving as a control portion, a memory 23, a display portion 24, an operating portion 25, a communication I/F 26, and a memory portion 28 constituted by redundant arrays of inexpensive disks (RAID) or the like, are connected to a data BUS.

In this case, the CPU 22 in accordance with the present embodiment corresponds to an example of “transmitting means”, “question information memory means”, “learning memory means”, “billing means” and “receiving means” for receiving various information. Further, the memory portion 28 in accordance with the present embodiment corresponds to an example of “question information memory means”, “learning memory means” and “billing means”. Further, the communication I/F 26 in accordance with the present embodiment corresponds to an example of “transmitting means” and “receiving means” for receiving the various information.

In the memory portion 28 of the learning server 21, there are installed a program for managing the learning system 10 shown in FIG. 1, more particularly a program supplying, acquiring and managing the information relating to the various learning such as a program for executing a communication with the terminal devices 41A, 41B, . . . and the like.

The program installed in the memory portion 28 of the learning server 21 in accordance with the present embodiment particularly includes the following programs.

(A) A program of receiving a learning operation information (at least one of a character information, a pointer positional information, a decision information and a cancellation information) on the basis of the operation of the operating portion, in correspondence to the learning (question) information sequentially transmitted from the student terminal and displayed on the display portion in the student terminal.

(B) A program of sequentially transmitting a signal sequentially displaying an image relating to the learning operation information on the display portion in the instructor terminal, to the instructor terminal.

(C) A program of receiving a question request signal from the instructor terminal.

(D) A program of transmitting the question information to the student terminal in correspondence to the question request signal.

(E) A program of storing the learning operation information sequentially transmitted from the student terminal.

(F) A program of executing billing to the student terminal and/or the instructor terminal in the case that the function is made effective.

The CPU 22 is structured such as to execute various operations in accordance with the programs installed in the memory portion 28, and the program itself temporarily stores variables, data and the like generated by the operating program in the memory 23, and controls each of the circuit portions in correspondence to the operation mentioned above. Although details will be mentioned later, various processes are executed in accordance with the control program and various contents and programs installed in the memory portion 28. In other words, the CPU 22 transmits and receives the various information relating to the learning to and from each of the terminal devices 41A, 41B, . . . via a circuit connected to the communication I/F 26 and the network 51.

[Structure of Memory Portion in Learning Server]

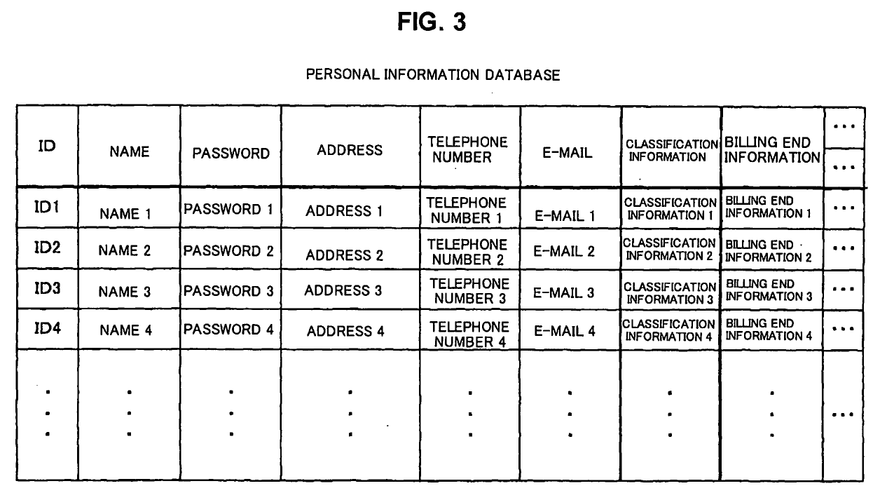

Further, databases as shown in FIGS. 3 to 6 are stored in the memory portion 28 in the learning server 21 mentioned above.

In this case, the “database” in accordance with the present embodiment is structured such as to supply a procedure for inputting, renewing and searching the data, and achieves a centralized control of the information, and includes a relational database executing a process while associating a record in a certain table with a record in another table.

[Personal Information Database]

“Personal information database” is stored in the memory portion 28 as shown in FIG. 3.

FIG. 3 is an explanatory view conceptually showing memory contents of the personal information database provided in the learning server 21 in accordance with the present embodiment.

The personal information database is structured such that the information of the student utilizing the learning system 10 is stored in an associated manner, and various information such as “ID”, “name”, “password”, “address”, “telephone number”, address of “e-mail”, “classification information” indicating “classification” of the student and the instructor, “billing end information” and the like are associated in the items.

The learning server 21 receives “ID” and “password” of the student from the terminal devices 41A, 41B, . . . , thereby referring to the personal information database, and decides the communicating end information such as the mail address or the like.

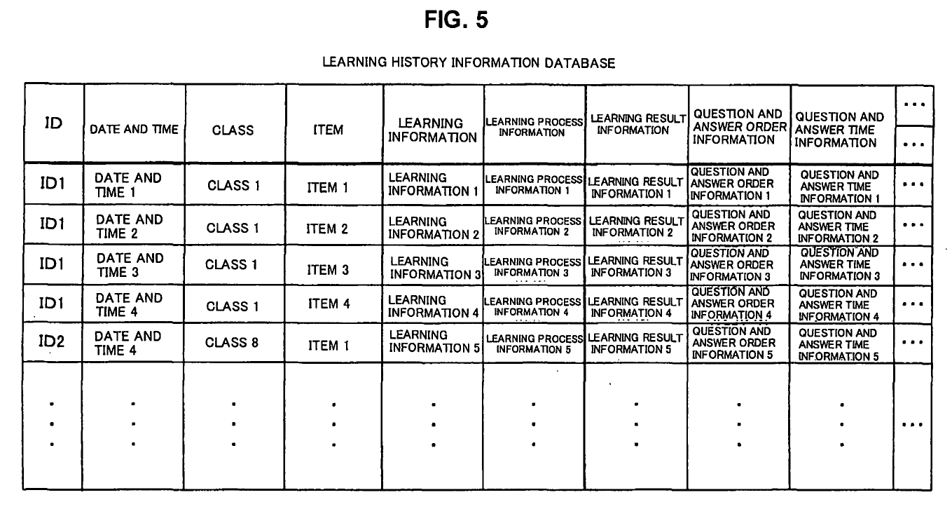

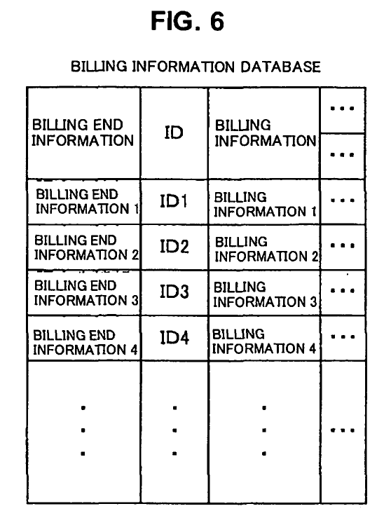

Further, the items such as “ID” and the like in the personal information database are coordinated with a learning history information database (refer to FIG. 5), and a billing information database (refer to FIG. 6) mentioned below.

The “billing end information” is coordinated with a billing information database mentioned below for renewing the billing information database.

[Learning Information Database]

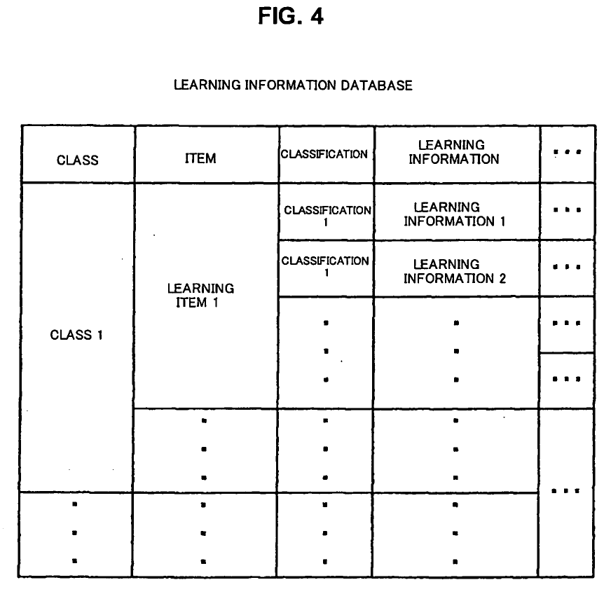

Further, “learning information database” is stored in the memory portion 28 as shown in FIG. 4.

FIG. 4 is an explanatory view conceptually showing stored contents of the learning information database provided in the learning server 21 in accordance with the present embodiment.

Detailed information of the learning information supplied to the student are stored in the learning information database in an associated manner. Various information is associated with these items, such as “class”, “item”, “classification” (for discriminating whether simple “learning information” or “question information” such as a test, a check list, an evaluation or the like), “learning information” and the like.

The “class” information corresponds to a large contents including a plurality of learning information supplied by the present learning server 21, indicates a field relating to the learning, corresponds, for example, to “culture in Edo period in history” and “quadratic function in mathematics”, and is supplied to the terminal device 41A from the present learning server 21 via the network 51.

The “item” information corresponds to a middle contents including a plurality of learning information supplied by the present learning server 21, and one “class” is structured by collecting a plurality of items. In other words, a plurality of “item” information is stored so as to be associated with the one “class” information. The “item” information corresponds, for example, to “limner in culture in Edo period” in the case of exemplifying the “culture in Edo period in history” mentioned above, and is supplied to the terminal device 41A from the present learning server 21 via the network 51.

The “classification” information corresponds to the information for differentiating whether “simple learning information” (passive information for the student) offering the simple information relating to the learning, or “question information” (active information for the student) of a question form relating to the learning such as a test, a check list, an evaluation or the like, as mentioned above.

The “learning information” corresponds to an actual learning information, and “simple learning information” or “question information” is stored in correspondence to the associated “classification” information as mentioned above. The “learning information” mentioned above is supplied to the terminal devices 41A, 41B, . . . from the present learning server 21 via the network 51.

As mentioned above, since “the learning information includes the question information of the question form” in the learning server 21, the structure is made such as to include the question information in addition to the passive information for the student. Accordingly, since the student thinks independently and learns in comparison with the conventional system sending learning materials, a learning efficiency is improved. Therefore, it is possible to supply the learning capable of improving a motivation for learning of the student.

[Learning History Information Database]

Further, “learning history information database” is stored in the memory portion 28 as shown in FIG. 5.

FIG. 5 is an explanatory view conceptually showing the memory contents of the learning history information database provided in the learning server 21 in accordance with the present embodiment.

The learning history information database indicates a history of the learning information which the present learning server 21 supplies to the terminal device 41A, and various information is stored therein in an associated manner, such as “ID (student and instructor)”, “date and time”, “class”, “item”, “learning information”, “learning process information”, “learning result information”, “question and answer order information”, “question and answer time information” and the like.

The “date and time” information indicates a date and time at which the learning server 21 supplies the learning information to the terminal device 41A, and is stored so as to be associated with the “ID” information of the student operating the terminal device 41A to be supplied.

The “class”, “item” and “learning information” indicate “class”, “item” and “learning information” which the present learning server 21 supplies to the terminal device 41A, and are stored so as to be associated with the “ID” and “date and time” mentioned above.

Further, the “class”, “item” and “learning information” stored in the learning history information database are associated with the “class”, “item” and “learning information” stored in the “learning information database” (refer to FIG. 4) mentioned above.

The “learning process information”, “learning result information”, “question and answer order information”, and “question and answer time information” indicate the “learning process information”, “learning result information”, “question and answer order information”, and “question and answer time information” supplied to the present learning server 21 from the terminal device 41A (or the terminal device 41B), and are stored so as to be associated with the “ID”, “date and time”, “class”, “item” and “learning information” mentioned above.

The “learning process information” indicates a process of the learning operation information on the basis of the operation of the operating portion of the terminal device 41A with respect to the learning information supplied to the terminal device 41A (or the terminal device 41B) from the present learning server 21.

The learning operation information includes a character information, a pointer positional information, an input decision information and an input cancellation information with respect to the learning information supplied to the terminal device 41A (or the terminal device 41B) from the present learning server 21. Further, a face information and a voice information are included in the learning operation information.

The “learning process information” corresponds to an information stored so as to be associated in the case that the “learning information” is constituted by the “question information”. In the case that the “learning information” is constituted by the “simple learning information”, “FF” indicating a state in which no information is stored is stored.

In the case that the “question information” is constituted, for example, by a certain one question (for example, “which is a work of Hokusai Katsushika?) supplied to the student, and a selective answer type information that a plurality of answers are associated with the question (for example, “1. FUGAKU SANJUROKUKEI”, “2. TOKAIDO GOJUSANTSUGI”, “3. KANSEI SANBIJIN”), the “learning process information” includes “positional information” of the pointer until the input of the answer is finished (for example, selecting 1 after selecting and canceling 2, directly selecting 2, and the like). This is not limited to the “positional information” of the pointer. In the case that the “question information” is constituted, for example, by a certain one question (for example, “which is a work of Hokusai Katsushika?) supplied to the student, and an input answer type information that an input box is displayed with respect to the question so as to be input by an answer, the “learning process information” includes an input information to the input box until the input of the answer is finished (for example, inputting FUGAKU SANJUROKUKEI after inputting and deleting TOKAIDO GOJUSANTSUGI, inputting FUGAKU SANJUROKUKEI after inputting and deleting FUGAKU “GOJUSAN”KEI, and the like).

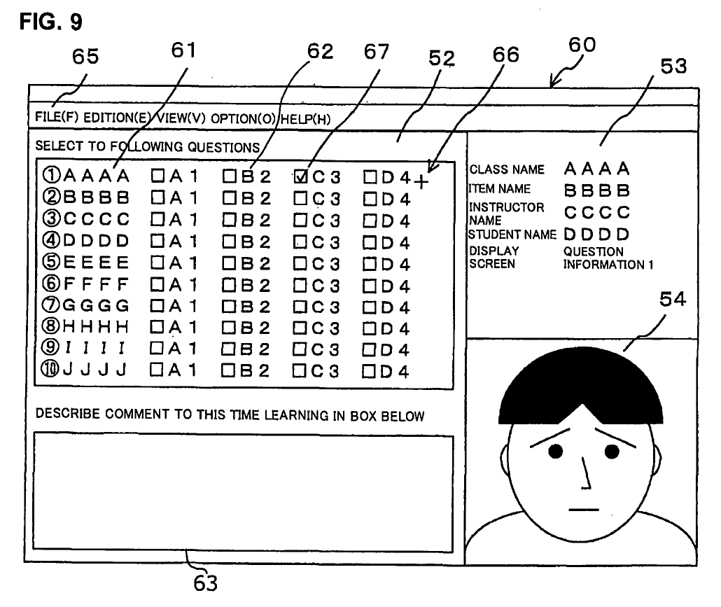

In other words, in this “learning process information”, for example, there is stored a history of the positional information of the pointer (refer to FIG. 9) on the screen, the input character information to the input box and the like, on the basis of the operation of the mouse or the like of the student. It corresponds to an information indicating a motion and a display per fixed time unit of the pointer, the character information or the like displayed on the screen, on the basis of the operation of the student.

Further, the “learning process information” is not limited to the information indicating the motion and the display per the fixed time unit of the pointer, the character information or the like displayed on the screen, on the basis of the operation of the student, but a face information, a voice information or the like per fixed time unit of the student is stored in addition to the above information.

In this case, the “learning process information” in accordance with the present embodiment is set to the information stored so as to be associated with the “question information” in the “learning information”, however, is not limited to this, but may be set to an information stored so as to be associated with the “simple learning information”. In this case, the “learning process information” may be structured such as to store a positional information of the pointer such as an operation for scrolling a learning material displayed on the screen of the terminal device 41, on the basis of the operation of the student. Further, it may be constituted by an information simply indicating an advance degree of the learning.

Next, the “learning result information” indicates the result of the learning operation information on the basis of the operation of the operating portion of the terminal device 41A with respect to the learning information supplied to the terminal device 41A (or the terminal device 41B) from the present learning server 21.

The “learning result information” corresponds to the information stored so as to be associated in the case that the “learning information” is constituted by the “question information”. In the case that the “learning information” is constituted by the “simple learning information”, there is stored “FF” indicating the state in which no information is stored.

The “learning result information” indicates the decision information which the student finally inputs. For example, it indicates the answer information which the student determines to the “question information” (for example, “which is a work of HOKUSAI KATSUSHIKA?”). It may be indicates as a question and answer information.

In this case, the “learning result information” in accordance with the present embodiment is set to the information stored so as to be associated with the “question information” in the “learning information”, however, is not limited to this, but may be set to the information stored so as to be associated with the “simple learning information”. In this case, the “learning result information” may be constituted by the information indicating a final degree of progress to what extent the learning is progressed.

Next, the “question and answer order information” indicates the result of the learning operation information on the basis of the operation of the operating portion of the terminal device 41A transmitted to the learning server 21 from the terminal device 41A with respect to the learning information (the question information supplied to the terminal device 41A (or the terminal device 41B) from the present learning server 21.

The “question and answer order information” corresponds to the information stored so as to be associated in the case that the “learning information” is constituted by the “question information”. In the case that the “learning information” is constituted by the “simple learning information”, the “FF” indicating the state in which no information is stored is stored.

The “question and answer order information” indicates the answer order with respect to a plurality of question items included in the “question information”.

In the case that a plurality of questions are supplied, the student does not necessarily answer in the sequential order from the first to the last, but may answer a difficult question later or may answer a favorite question first. The “question and answer order information” indicates the unique order of the answer of the student executed with respect to a plurality of questions.

In this case, the “question and answer order information” in accordance with the present embodiment is set to the information stored so as to be associated with the “question information” in the “learning information”, however, is not limited to this, but may be set to the information stored so as to be associated with the “simple learning information”. In this case, the “question and answer order information” may be structured, for example, such that the order or the like displaying the learning material displayed on the screen of the terminal device 41 is stored on the basis of the operation of the student.

Next, the “question and answer time information” indicates the result of the learning operation information on the basis of the operation of the operating portion of the terminal device 41A transmitted to the learning server 21 from the terminal device 41A, with respect to the learning information (the question information) supplied to the terminal device 41A (or the terminal device 41B) from the present learning server 21.

The “question and answer order information” corresponds to the information stored so as to be associated in the case that the “learning information” is constituted by the “question information”. In the case that the “learning information” is constituted by the “simple learning information”, the “FF” indicating the state in which no information is stored is stored.

The “question and answer order information” indicates the time required for answering to one question item in a plurality of question items included in the “question information”. In other words, it indicates the time counted until an input to the next question item is determined after an input to one question item is determined.

In this case, in accordance with the present embodiment, the time counted until the input to the next question item is determined after the input to the one question item is determined is stored, however, the structure is not limited to this, but a time required to a plurality of question items, a time required to all the question items or the like may be stored.

In this case, the “question and answer time information” in accordance with the present embodiment is set to the information stored so as to be associated with the “question information” in the “learning information”, however, is not limited to this, but may be set to the information stored so as to be associated with the “simple learning information”. In this case, the “question and answer time information” may be structured, for example, such that there is stored a time or the like until the display of the learning material displayed on the screen of the terminal device 41 is finished after displaying it on the basis of the operation of the student.

As mentioned above, since the learning server 21 is structured such as to store the learning information sequentially displayed on the terminal device 41A (or the terminal device 41B), the sequentially displayed face image, the sequentially generated voice information and the like, it is possible to again output the learning information, the face image and the voice to the instructor, it is possible to further display (generate) the learning condition such as the response of the learning information of the student and the like in detail, and it is possible to supply the useful information capable of supplying the high-quality learning information to the student.

Of course, the structure may be made such that the terminal device 41A stores at least one of the transmitted learning information, face information and voice information, and since it is structured such as to store the sequentially displayed learning information, the sequentially displayed face image, the sequentially generated voice and the like, it is possible to again output the learning information, the face image, the voice and the like to the student, it is possible to further display the learning condition such as the response of the learning information of the student and the like in detail and sequentially, and it is possible to supply the useful learning information to the student.

Further, the structure may be made such that the terminal device 41B stores at least one of the transmitted question information, face information and voice information, and since it is structured such as to store the sequentially displayed question information, the sequentially displayed face image, the sequentially generated voice and the like, it is possible to again output the question information, the face image, the voice and the like to the instructor, it is possible to display the learning information and the learning environment such as the learning information and the aspect of the instruction of the instructor to the student in detail and sequentially, it is possible to supply the useful learning information to the instructor, and it is possible to supply the useful learning information to the student indirectly.

Of course, the structure may be made such that the terminal device 41A stores at least one of the question information, the face information and the voice information transmitted from the terminal device 41B, and since it is structured such as to store the sequentially displayed question information, the sequentially displayed face image, the sequentially generated voice and the like, it is possible to again output the question information, the face image, the voice and the like to the student, it is possible to further display the learning information and the learning environment such as the learning information, the aspect of the instruction and the like of the instructor to the student in detail and sequentially, and it is possible to supply the useful information capable of supplying the high-quality learning information to the student.

Further, the structure may be made such as to display (generate) at least one of the learning information, the face information and the voice information stored in the learning server 21, in response to the operation of the terminal device 41A and the terminal device 41B.

Further, the structure may be made such that the question information is constituted by a plurality of question items, a plurality of question items are displayed on the display portion of the terminal device 41A all at once, and the answer order to a plurality of question items is stored. Accordingly, it is possible to output only the answer order corresponding to an important factor without outputting all the stored information, and a simple and convenient structure is achieved. Of course, it is possible to output the answer contents and a simple and convenient structure is achieved.

Further, the structure may be made such that the question information is constituted by one question item, one question item is sequentially displayed on the display portion of the terminal device 41A, and the answer time to one question item is stored. Accordingly, it is possible to output only the answer time corresponding to an important factor without outputting all the stored information, and a simple and convenient structure is achieved. Of course, it is possible to output the answer contents and a simple and convenient structure is achieved.

[Billing Information Database]

Further, the “billing information database” is stored in the memory portion 28 as shown in FIG. 6.

FIG. 6 is an explanatory view conceptually showing memory contents of the billing information database provided in the learning server 21 in accordance with the present embodiment.

The billing information database indicates the billing information for executing the billing in response to the “learning information” supplied to the terminal devices 41A and 41B from the learning server 21. The various information such as “billing end information”, “ID”, “billing information” and the like are stored in the billing information database so as to be associated.

The “billing end information” is structured such that the information of the billing end to which the billing is executed to the student or the instructor, for example, identification information of a credit card, identification information of a bank account or the like is stored. Further, the “billing end information” is associated with the “billing end information” positioned in the personal information database shown in FIG. 3.

The “ID” information corresponds to the identification information applied to each of the students and the instructors utilizing the present learning system. Further, the “ID” information is associated with the “ID information” positioned in the personal information database shown in FIG. 3, and the “ID information” positioned in the learning history information database shown in FIG. 5.

The “learning information” corresponds to an actual learning information, and the “simple learning information” or the “question information” is stored in correspondence to the associated “classification” information, as mentioned above. The “learning information” mentioned above is supplied to the terminal devices 41A, 41B, . . . via the network 51 from the present learning server 21.

The “billing information” corresponds to an actual billing information, and indicates a money amount information charged in correspondence to the “learning information” supplied to the terminal devices 41A and 41B from the learning server 21.

The billing information may indicate the billing information defined in correspondence to each of the supplied “learning information”, or may indicate the billing information defined in correspondence to the time of utilizing the present learning system.

As mentioned above, since the structure is made such that the function such as the transmitting means in the learning server 21 is made effective, thereby executing the billing, it is possible to achieve the billing to the instructor and the student using the learning server 21, and it is useful for the manager of the learning server.

[Question Information Database]

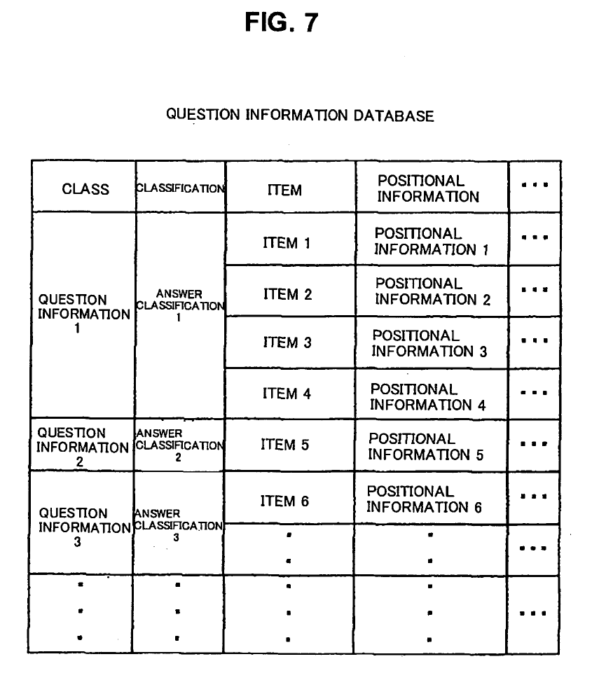

Further, the “question information database” is stored in the memory portion 28 as shown in FIG. 7.

FIG. 7 is an explanatory view conceptually showing the stored contents of the question information database provided in the learning server 21 in accordance with the present embodiment.

The question information database indicates the detailed contents of the question information for supplying the question information in the “learning information” to the terminal devices 41A and 41B from the learning server 21. The various information such as the “question information”, the “item”, the “positional information”, the “classification” and the like are stored in the question information database so as to be associated.

The “question information” includes the information of test, check list, evaluation and the like relating to the learning. The information, for example, “which is a work of HOKUSAI KATSUSHIKA?” is stored in the “question information”.

Next, the “answer classification” corresponds to the information for discriminating the classification of the answer method to the “question information”. The classification of the answer includes, for example, the selective answer method of selecting one answer from a plurality of answers (checking and inputting one check box from a plurality of check boxes), a free answer method of requesting an input of characters (inputting characters in a blank box), and the like.

Next, the “item” is stored so as to be associated with the “question information” mentioned above. In the case of the selective answer method in which a plurality of answers are prepared for the “question information” mentioned above, a plurality of “items” are associated with one “question information”. The “item” information in this case indicates one alternative among a plurality of alternatives information (and the check box information displayed so as to be associated therewith). For example, in the example mentioned above, there are listed up “1. FUGAKU SANJUROKUKEI”, “2. TOKAIDO GOJUSANTSUGI”, “3. KANSEI SANBIJIN”.

Further, in the case of the free answer method of requesting the input of the characters or the like without preparing a plurality of answers to the “question information” mentioned above, one “item” is associated with one “question information”. The “item” information in this case indicates the blank box information.

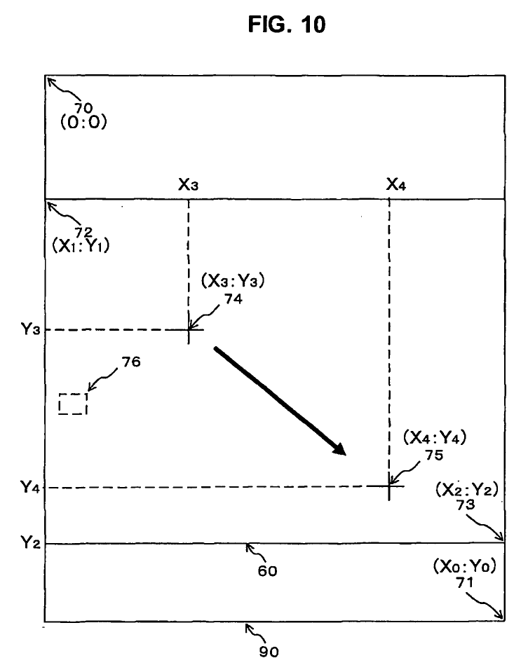

Next, the “positional information” is stored so as to be associated with the “question information” mentioned above. The “positional information” indicates a position on the screen of the check box or the like displayed so as to be associated with the “item” information mentioned above. The “positional information” is shown by coordinate information. A description will be given later of details thereof with reference to FIG. 10.

[Structure of Terminal Device]

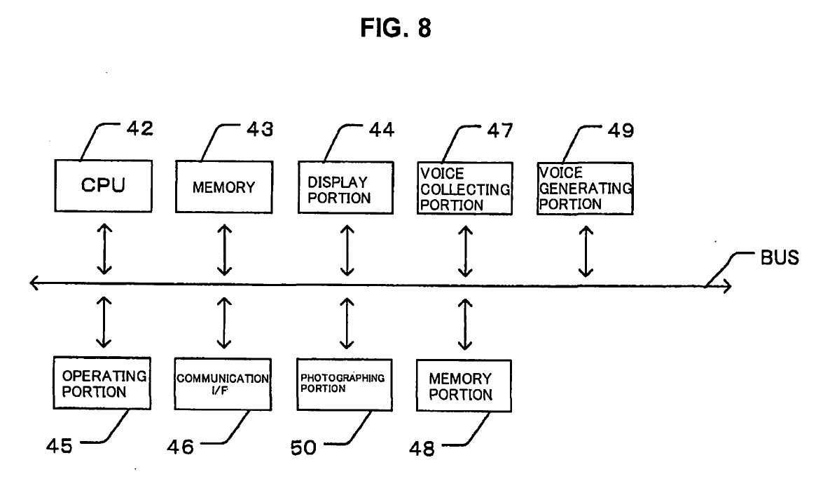

FIG. 8 is a block diagram showing a control circuit of the terminal device in accordance with the present embodiment. In this case, the description is given of the terminal device 41A, however, the other terminal devices 41B, . . . have the same structure.

As shown in FIG. 8, in the terminal device 41A, there are connected to a data bus BUS, a memory 43, a communication interface (hereinafter referred to as a communication I/F) 46 transmitting and receiving a signal, a display portion 44 constituted by a liquid crystal panel, a CRT or the like, an operating portion 45 constituted by a keyboard, a mouse, a jog dial or the like, a memory portion 48 for storing various data, a voice collecting portion 47 for collecting the voice such as a microphone or the like, a voice generating portion 49 for generating the voice such as a speaker or the like, and a photographing portion 50 for photographing the image such as a camera or the like.

The CPU 42 is structured such as to execute various operations in accordance with an operating program installed in the memory portion 48, and the operating program itself temporarily stores variables generated by the operating program in the memory 43, and controls each of the circuit portions in correspondence to the operation. Various process contents of the CPU 42 are displayed on the display portion 44 as occasion demands.

In this case, the CPU 42 in accordance with the present embodiment corresponds to an example of “display control means”, “learning operation information collecting means”, “transmitting means”, “voice generating means”, “photographing means”, “voice collecting means”, “selecting means”, and “receiving means” for receiving various information. Further, the communication I/F 46 in accordance with the present embodiment corresponds to an example of “transmitting means” and “receiving means” for receiving various information. In this case, the display portion 44 in the present embodiment corresponds to an example of “display portion”. Further, the voice collecting portion 47 in accordance with the present embodiment corresponds to an example of “voice collecting means”. Further, the voice generating means 49 in accordance with the present embodiment corresponds to an example of “voice generating means”. Further, the operating means 45 in accordance with the present embodiment corresponds to an example of “operating means”. Further, the photographing means 50 in accordance with the present embodiment corresponds to an example of “photographing portion”.

[Description of Display Screen of Terminal Device]

A description will be given of a display screen of a control circuit of the terminal device in accordance with the present embodiment with reference to FIGS. 9 and 10. In this case, the display screen described below indicates a display screen of the terminal device 41B corresponding to the instructor terminal, however, the terminal device 41A corresponding to the student terminal has a similar display screen.

A menu image 65 is displayed on a display screen 60 in an upper side thereof. Various functions can be executed by operating the menu image 51. Further, a question image (learning information and question information) 52 is displayed in a lower side of the menu image 65. The question image includes a plurality of question information 61, an alternative image 62 to a plurality of question information 61, a description image 63 thereto and the like. Further, a learning operation information in the student terminal 41A is displayed as a learning operation information in response to the question information (the learning information) mentioned above in the instructor terminal 41B. In the student terminal 41A, the learning operation information in the instructor terminal 41B is displayed. For example, in the instructor terminal 41B, there are displayed a positional image 66 of a pointer in the student terminal 41A, a check image 67 of the check box and the like. In addition, there are character image (not shown) described in the description image 63, a cancellation image (not shown) of the check box and the like. Further, an instructing operating information in the instructor terminal 41B is displayed as the instructing operation information in response to the operation of the instructor, in the student terminal 41A, and the learning operating information in the student terminal 41A is displayed in the instructor terminal 41B. For example, in the student terminal 41A, there are also displayed the positional image 66 of the pointer in the instructor terminal 41B, the check image 67 of the check box and the like. In addition, there are the character image (not shown) described in the description image 63, the cancellation image (not shown) of the check box and the like. Further, certain one learning operation information is displayed on the other student terminal and the instructor terminal.

As shown in FIG. 10, display reference positional information 72 and 73 are set on the display screen. The display reference positional information 72 and 73 are relatively set with respect to an entire image including the learning information. Further, a cursor positional information 74 in the display screen is also set relatively with respect to the entire image including the learning information. The display reference positional information 72 and 73, and the cursor positional information 74 mentioned above are extracted by the student terminal 41A and the like, and are transmitted and received as the data indicating the relative positional information with respect to the entire image including the learning information between the student terminal 41A and the learning server 21, and between the learning server and the instructor terminal 41B.

As a concrete example, there is taken up the case that an image information (including the learning information) 90 of a coordinate (X₀, Y₀) denoted by reference numeral 71 from a coordinate (0, 0) denoted by reference numeral 70 is supplied from the learning server 21, and an area of a coordinate (X₂, Y₂) denoted by reference numeral 73 from a coordinate (X₁, Y₁) denoted by reference numeral 72 among the image information 90 is displayed as a display screen 60 on the display portion 44A.

In this case, the student terminal 41A extracts (collects) (X₁, Y₁) and (X₂, Y₂) as the display reference positional information on the basis of the image displayed on the display portion 44A, and transmits (X₁, Y₁) and (X₂, Y₂) as the display reference positional information to the learning server 21. Of course, the learning server 21 transmits (X₁, Y₁) and (X₂, Y₂) as the display reference positional information to the instructor terminal 41B. As mentioned above, the learning server 21 and the instructor terminal 41B can recognize the display screen in the student terminal 41A on the basis of the display reference positional information. Of course, even in the case that the screen is scrolled, the display reference positional information is sequentially extracted and transmitted. Accordingly, even in the case that the display screen in the student terminal 41A is scrolled, the display screen can be recognized by the learning server 21, and the instructor terminal 41B.

Further, the cursor position 74 is extracted as a coordinate (X₃, Y₃) on the basis of the positional relation from the display reference positional information 72 and 73. The student terminal 41A extracts (collects) the cursor positional relation (X₃, Y₃) on the basis of the positional relation between the display reference positional information (X₁, Y₁) and (X₂, Y₂) and the cursor position, and transmits the cursor positional information (X₃, Y₃) to the learning server 21. Of course, the learning server 21 transmits the cursor positional information (X₃, Y₃) to the instructor terminal 41B. As mentioned above, the learning server 21 and the instructor terminal 41B can recognize the cursor position. Further, when the cursor position is changed to the sign 75 from the sign 74, the cursor positional information is changed to (X₄, Y₄) from (X₃, Y₃), and the learning server 21 and the instructor terminal 41B can recognize the cursor position by executing the control mentioned above.

Further, the learning server 21 and the instructor terminal 41B can recognize a fact that a certain check box is clicked on the basis of the cursor position recognized as mentioned above, the positional information of the check box or the like (an operated object) positioned to the learning information (the question information), and the operation information of the decision and the cancellation. For example, there is exemplified a case that the check box is displayed so as to be arranged in an area surrounded by a dotted line shown by a sign 76 in FIG. 10. In the learning server 21, the positional information of the previously stored check box is stored as the learning information. In the case that the positional information of the check box coincides with the cursor positional information, and the determining operation is executed, the cursor positional information and the decision information (or the data indicating that the certain check box is operated) are supplied to the learning server 21 from the student terminal 41A. Further, these information is supplied to the instructor terminal 41B from the learning server 21. Accordingly, the learning server 21, the student terminal 41A and the instructor terminal 41B can recognize that the check box is checked. In addition to the check box, it is possible to employ a GUI image operable in correspondence to the learning information (the question information), for example, a button, a list box, a radio button, a combo box and the like.

As mentioned above, the learning operation information corresponds to a concept including not only the result obtained by the fact that the operating portion is operated by the student, but also the result obtained by the fact that the operating portion is not operated by the student, for example, includes a case that the pointer of the mouse is stopped as a predetermined position. This is similarly applied to the instructing operation information.

Further, since the character information, the pointer positional information, the decision information and the cancellation information operated by the student are transmitted to the instructor terminal, it is possible to further display the learning condition such as the response of the learning information of the student and the like to the instructor in detail and sequentially, and it is possible to supply the useful information capable of supplying the high-quality learning information to the student.

Further, the structure may be made such that “the pointer positional information is constituted by a positional information corresponding to the image relating to the learning information displayed on the display portion in the student terminal”. In this case, since only the positional information is transmitted without transmitting the image information, it is possible to prevent a fault due to a communication delay. Of course, the structure may be made such that “the pointer positional information is transmitted by the transmitting means in the instructor terminal, and corresponds to a positional information corresponding to an image relating a question information displayed on the display portion in the student terminal”. In this case, it is possible to supply the useful learning information to the student.

In this case, the “pointer positional information” is based on the operation of the operating portion, and corresponds, for example, to various aspects such as a pointer used for operating a mouse, a pointer used for operating a keyboard and the like.

Further, the pointer information transmitted by the transmitting means in the student terminal is displayed as a pointer information image on the display portion by the display means in the instructor terminal, however, may have “a determining means for determining a display aspect of the pointer information image”, whereby even in the case that the image is displayed small, it is possible to easily view the pointer information image. For example, it includes a function of determining a display color of the pointer information image, or flashing the display of the pointer information image.

Further, as shown in FIG. 9, an image 53 indicating a class or the like is displayed in a right side of the question image 52, and a face image 54 is displayed in a lower side thereof. As the face image 54, a face information of the student operating the student terminal 41A is displayed in the instructor terminal 41B, and a face information of the instructor operating the instructor terminal 41B is displayed in the student terminal 41A. Further, voice information can be transmitted and received to and from each other in addition to the face information.

As mentioned above, since the structure is made such as to sequentially collect and transmit the face information of the student and the voice information generated by the student, sequentially display the image relating to the transmitted face information on the display portion of the instructor terminal, and generate the transmitted voice information by the voice generating means of the instructor terminal, it is possible to display the learning condition such as a facial expression, a voice tone and the like of the student in detail and sequentially to the instructor so as to generate as the voice, whereby it is possible to further supply a useful information capable of providing the high-quality learning information to the student.

Further, the structure may be made such that “the display control means in the instructor terminal has a function of displaying the face information and the learning operation information in parallel (simultaneously) on the display portion”. Of course, the structure may be made such that “the voice generating means in the instructor has a function of generating a voice information in parallel to displaying the face information and the learning operation information on the display portion by the display control means in the instructor terminal”, whereby it is possible to supply a useful information to the instructor at a distance.

Further, the structure may be made such that “the instructor terminal has a photographing means for sequentially photographing a face information of the instructor, a voice collecting means for sequentially collecting a voice information generated by the instructor, and a transmitting means for transmitting the face information sequentially photographed by the photographing means and the voice information sequentially collected by the voice collecting means to the student terminal”, and the structure may be made such that “the student terminal has a display control means for sequentially displaying the face information transmitted by the transmitting means in the instructor terminal on the display portion, and a voice generating means for generating a voice information transmitted by the transmitting means in the instructor terminal”.

In accordance with the structure mentioned above, it is possible to display the learning condition such as the facial expression, the voice tone or the like of the instructor in detail and sequentially as the image and generate as the voice to the student, and it is possible to further supply the useful information capable of providing the high-quality learning information and learning environment to the student.

In this case, the transmitting means of the student terminal and the instructor terminal may be separately structured such as a first transmitting means for transmitting the face image, a second transmitting means for transmitting the voice information, and a third transmitting means for transmitting the learning information. Of course, the transmitting means of the instructor terminal may be separately structured such as a first transmitting means for transmitting the face information, a second transmitting means for transmitting the voice information, and a third transmitting means for transmitting the question information.

[Description of Operation of System]

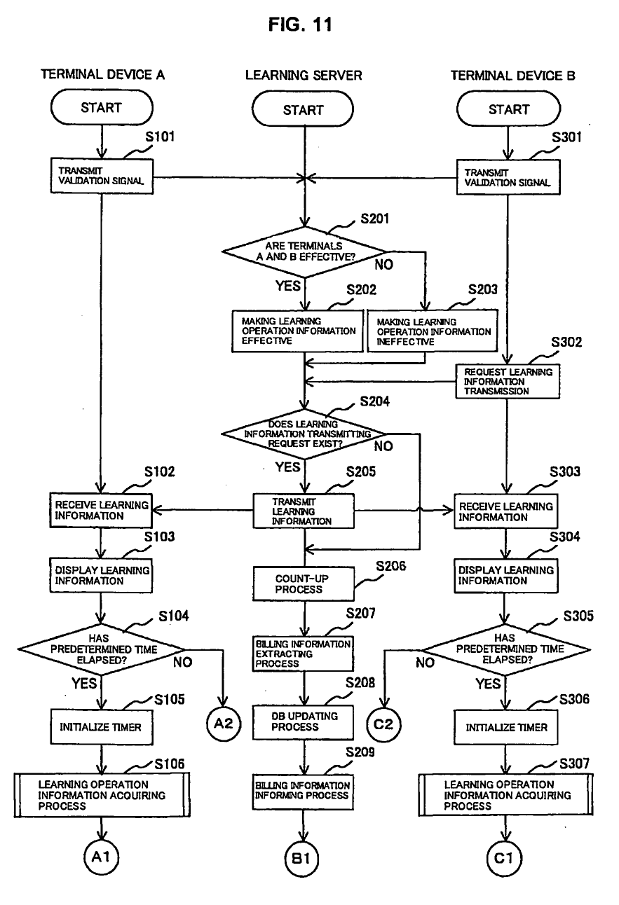

A description will be given of a system operating process in the learning system 10 mentioned above with reference to flowcharts in FIGS. 11 to 14.

In the following description, it is assumed that the learning system 10 is started, the variables used in the CPU 22 in the learning server 21 mentioned above, and the CPU 42 in the terminal devices 41A, 41B, . . . are initialized to a predetermined value, and are steadily operated. Further, it is assumed that sub-routines shown in FIGS. 11 to 14 is called at a predetermined timing. Further, in the present sub-routines, it is assumed that there is executed processes of supplying, acquiring and managing the information relating to the learning by using the learning server 21 and the terminal device 41A.

[Process of Entire System]

As shown in FIG. 11, in the terminal devices 41A and 41B, there is first executed a validation signal transmitting process (step S101 and step S301). In this process, the CPU 42A (42B) transmits a validation signal to the server 21 via the communication I/F 46A (46B). The validation signal includes the “ID” information of the student and the instructor, the password information and the like. In the case that the process is finished, the process is transferred to a step S102 (step S202).

On the other hand, in the learning server 21, there is judged whether or not the terminal device 41A and the terminal device 41B are effective (step S201). In this process, the CPU 22 receives the validation signal from the terminal devices 41A and 41B, and judges whether or not the terminal device 41A and the terminal device 41B are effective. In the case that the CPU 22 determines that the terminal device 41A and the terminal device 41B are effective, the CPU 22 transfers the process to the step S202, and in the case that it determines that the terminal device 41A and the terminal device 41B are not effective, it transfers the process to a step S203.

Next, in the case that it is determined that the terminal device 41A and the terminal device 41B are effective in the process of the step S201 mentioned above, the CPU 22 executes a process of making the learning operation information effective (step S202), and in the case that it is determined that the terminal device 41A and the terminal device 41B are not effective, the CPU 22 executes a process of making the learning operation information ineffective (step S203). In the case that the process is finished, the process is transferred to a step S204.

On the other hand, in the terminal device 41B, there is executed a learning information transmission requiring process (step S302). In this process, the CPU 42B applies the learning information transmission requirement to the server 21 via the communication I/F 46B. In the case that the process is finished, the process is transferred to a step S303.

On the other hand, in the server 21, it is judged whether or not the learning information transmission requirement is made (step S204). In this process, the CPU 22 judges whether or not the learning information transmission requirement is received from the terminal device 41B. In the case that the CPU 22 determines that it receives the learning information transmission requirement from the terminal device 41B, the CPU 22 transfers the process to a step S205, and in the case that the CPU 22 determines that it does not receive the learning information transmission requirement from the terminal device 41B, the CPU 22 transfers the process to a step S206.

Next, in the case that it is determined in the process of the step S204 mentioned above that the CPU 22 receives the learning information transmission requirement from the terminal device 41B, the CPU 22 executes the learning information transmitting process (step S205). In this process, the CPU 22 reads “class”, “learning item” and “learning information” on the basis of the learning history information database shown in FIG. 5 and the learning information database shown in FIG. 4 mentioned above. Further, it transmits the read information to the terminal devices 41A and 41B via the communication I/F 26. In the case that the process is finished, the process is transferred to the step S206.

Next, a count-up process is executed (step S206). In this process, the CPU 22 starts the count-up by a timer existing inside the CPU 22, and stores a count-up value in the memory 23 at a predetermined timing. In the case that the process is finished, the process is transferred to a step S207.

Next, there is executed a billing information extracting process (step S207). In this process, the CPU 22 reads the count-up value stored in the memory 23, and calculates the billing information on the basis of the read count-up value. In the case that the process is finished, the process is transferred to a step S208.

Next, there is executed a DB update process (step S208). In this process, the CPU 22 stores the billing information extracted in the step S207 mentioned above at a predetermined position of the billing information database (refer to FIG. 6). In the case that the process is finished, the process is transferred to a step S209.

Next, there is executed a billing information informing process (step S209). In this process, the CPU 22 transfers the billing information extracted in the process of the step S207 mentioned above to the terminal devices 41A and 41B via the communication I/F 26. In the case that the process is finished, the process is transferred to a step S210. In this case, the terminal devices 41A and 41B receiving the billing information store the received billing information and display it on the display portion 44.

Further, the billing information informing process in the step S209 in accordance with the present embodiment is executed each time of transmitting the learning information, however, the structure is not limited to this, but may be executed every predetermined time. Further, it may be constantly displayed on the display portions 44 of the terminal devices 41A and 41B, for example, displayed upon count-up every second.

On the other hand, in the terminal devices 41A and 41B, there is executed the learning information receiving process (step S102, and step S303). In this process, the CPU 42A (42B) receives the learning information (step S205) transmitted from the server 21 via the communication I/F 46A (46B). Further, CPU 42A (42B) stores the received learning information in the memory 43A (43B) and the memory portion 48A (48B). In the case that the process is finished, the process is transferred to the step S103 (step S304).

Next, there is executed the learning information display process (step S103, and step S304). In this process, the CPU 42A (42B) displays the received learning information on the display portion 44A (44B). In the case that the process is finished, the process is transferred to the step S104 (step S305).

Next, there is judged whether or not a predetermined time has passed (step S104, and step S305). In this process, the CPU 42A (42B) measures by the timer existing therein, reads the elapsed time data stored in the memory 43A (43B), and judges whether or not the predetermined time has passed. In the case that the CPU 42A (42B) determines that the predetermined time has passed, the CPU 42A (42B) transfers the process to the step S105 (step S306), and in the case that it determines that the predetermined time has not passed, it transfers the process to a step S112 (step S313).

Next, there is executed a timer initializing process (step S105, and step S306). In this process, the CPU 42A (42B) initializes the elapsed time data stored in the memory 43A (43B). In the case that the process is finished, the process is transferred to the step S106 (step S307).

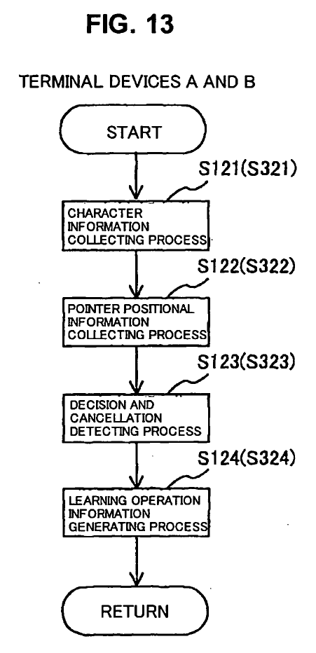

Next, there is executed a learning operation information acquiring process (step S106, and step S307). In this process, the CPU 42A (42B) acquires the learning operation information such as the character information, the pointer positional information, the decision information of the input information, the cancellation information of the input information and the like which are input on the basis of the operation of the operating portion 45 by the student and the instructor. A description will be in detail given later on the basis of FIG. 13. In the case that this process is finished, the process is transferred to the step S107 (step S308).

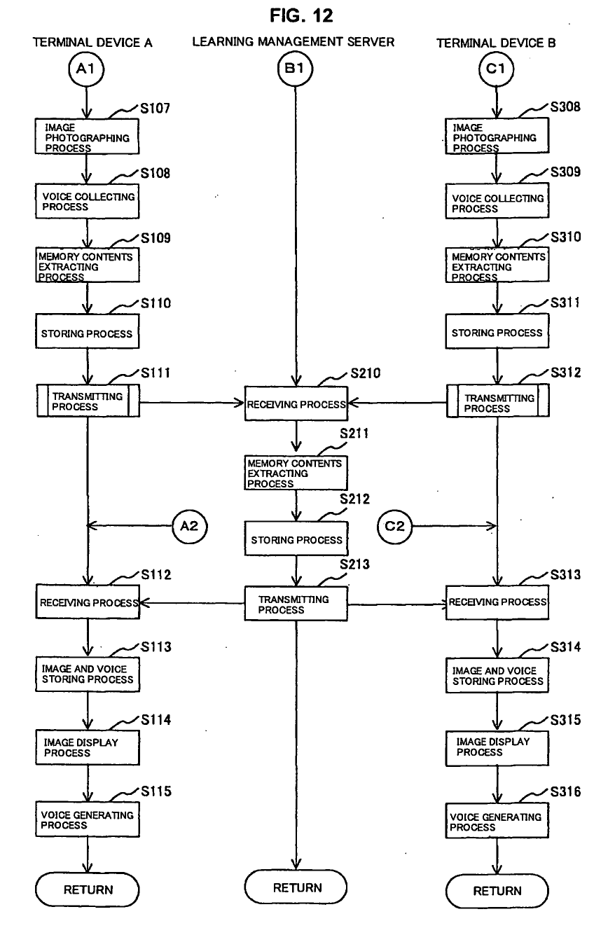

As shown in FIG. 12, there is next executed an image photographing process (step S107, and step S308). In this process, the CPU 42A (42B) photographs the face images of the student and the instructor by the photographing portion 50, and stores the photographed image information in the memory 43A (43B). In the case that the process is finished, the process is transferred to the step S108 (step S309).

Next, there is executed a voice collecting process (step S108, and step S309). In this process, the CPU 42A (42B) collects the voices of the student and the instructor by the voice collecting portion 47, and stores the collected voice information in the memory 43A (43B). In the case that this process is finished, the process is transferred to the step S109 (step S310).

Next, there is executed a memory contents extracting process (step S109, and step S310). In this process, the CPU 42A (42B) extracts the learning operation information such as the character information, the pointer positional information, the decision information of the input information, the cancellation information of the input information and the like, the face image information of the student and the instructor, and the voice information of the student and the instructor, which are acquired in the process of the steps S106 to S108 mentioned above. In the case that this process is finished, the process is transferred to the step S110 (step S311).

Next, there is executed a storing process (step S110, and step S311). In this process, the CPU 42A (42B) stores the learning operation information such as the character information, the pointer positional information, the decision information of the input information, the cancellation information of the input information and the like, the face image information of the student and the instructor, and the voice information of the student and the instructor, which are extracted in the process of the step S109 (step S310) mentioned above, as the learning history information managed in the terminal device side, in the memory portion 48A (48B). In the case that this process is finished, the process is transferred to the step S111 (step S312).

Next, there is executed a transmitting process (step S111, and step S312). In this process, the CPU 42A (42B) transmits data for transmission generated on the basis of the learning operation information such as the character information, the pointer positional information, the decision information of the input information, the cancellation information of the input information and the like, the face image information of the student and the instructor, and the voice information of the student and the instructor, which are stored in the memory 48A (48B) in the process of the step S110 (step S311) mentioned above, to the terminal devices 41A and 41B via the communication I/F 46. In the case that this process is finished, the process is transferred to the step S112 (step S313).

On the other hand, there is executed a receiving process (step S210) in the server 21. In this process, the CPU 22 receives the data for transmission generated on the basis of the learning operation information such as the character information, the pointer positional information, the decision information of the input information, the cancellation information of the input information and the like, the face image information of the student and the instructor, and the voice information of the student and the instructor, which are transmitted from the terminal devices 41A and 41B, and stores the data in the memory 23. In the case that this process is finished, the process is transferred to the step S211.

Next, there is executed a memory contents extracting process (step S211). In this process, the CPU 22 reads the data for transmission stored in the memory 23, and extracts the learning operation information such as the character information, the pointer positional information, the decision information of the input information, the cancellation information of the input information and the like, the face image information of the student and the instructor, and the voice information of the student and the instructor, from the read data for transmission. In the case that this process is finished, the process is transferred to the step S212.

Next, there is executed a storing process (step S212). In this process, the CPU 22 stores the learning operation information such as the character information, the pointer positional information, the decision information of the input information, the cancellation information of the input information and the like, the face image information of the student and the instructor, and the voice information of the student and the instructor, which are extracted in the process of the step S211 mentioned above, as “learning history information”, “learning result information”, “question and answer order information” and “question and answer time information” positioned to the learning history information database stored in the memory portion 28. In the case that this process is finished, the process is transferred to the step S213.

Next, there is executed a transmitting process (step S213). In this process, the CPU 22 transmits the learning operation information such as the character information, the pointer positional information, the decision information of the input information, the cancellation information of the input information and the like, the face image information of the student and the instructor, and the voice information of the student and the instructor, which are stored in the learning history information database of the memory portion 28 in the process of the step S212 mentioned above, to the terminal devices 41A and 41B via the communication I/F 26. Further, at this time, the CPU 22 transmits the information transmitted from the terminal device 41A to the terminal device 41B, and transmits the information transmitted from the terminal device 41B to the terminal device 41A. In some cases, the information transmitted from the terminal device 41A may be transmitted to the terminal device 41A, and the information transmitted from the terminal device 41B may be transmitted to the terminal device 41B. In the case that this process is finished, the flowchart in the learning management server is finished.

On the other hand, in the terminal devices 41A and 41B, there is executed a receiving process (step S112, and step S313). In this process, the CPU 42A (42B) receives the information transmitted from the server 21 via the communication I/F 46A (46B). Further, the information transmitted from the server 21 corresponds to the information of the terminal device 41B in the terminal device 41A, and corresponds to the information of the terminal device 41A in the terminal device 41B. Further, the information transmitted from the sever 21 is constituted by the learning operation information such as the character information, the pointer positional information, the decision information of the input information, the cancellation information of the input information and the like, the face image information of the student and the instructor, and the voice information of the student and the instructor. In the case that this process is finished, the process is transferred to the step S113 (S314).

Next, there is executed an image and voice storing process (step S113, and step S314). In this process, the CPU 42A (42B) stores the learning operation information such as the character information, the pointer positional information, the decision information of the input information, the cancellation information of the input information and the like, the face image information of the student and the instructor, and the voice information of the student and the instructor, which are received from the server 21 in the process of the step S112 (step S313) mentioned above, in the memory 43A (43B) and the memory portion 48A (48B). In the case that this process is finished, the process is transferred to the step S114 (step S315).

Next, there is executed an image display process (step S114, and step S315). In this process, the CPU 42A (42B) displays the image on the display portion 44A (44B) on the basis of the learning operation information such as the character information, the pointer positional information, the decision information of the input information, the cancellation information of the input information and the like, and the face image information of the student and the instructor, which are stored in the memory 43A (43B) and the memory portion 48A (48B) in the process of the step S113 (step S314) mentioned above. In the case that this process is finished, the process is transferred to the step S115 (step S316).

Next, there is executed a voice generating process (step S115, and step S316). In this process, the CPU 42A (42B) generates the voice in the voice generating portion 49A (49B) on the basis of the voice information of the student and the instructor, which are stored in the memory 43A (43B) and the memory portion 48A (48B) in the process of the step S113 (step S314) mentioned above. In the case that this process is finished, the flowchart in the terminal devices 41A and 41B is finished.

[Learning Operation Information Acquiring Process]

In the process of the step S106 (step S307) in the terminal device 41A (41B) shown in FIG. 11, a sub-routine shown in FIG. 13 is called.

In the learning operation information acquiring process shown in FIG. 13, there is first executed a character information collecting process (step S121, and step S321). In this process, the CPU 42A (42B) collects the input information of the operating portion 45A (45B) constituted by the keyboard or the like. The input information (the character information) is generated in response to the learning information displayed on the display portion 44A (44B), and is included in the learning operation information on the basis of the operation of the operating portion 45. In the case that this process is finished, the process is transferred to a step S122 (step S322).

Next, there is executed a pointer positional information collecting process (step S122, and step S322). In this process, the CPU 42A (42B) collects the pointer positional information indicating the pointer position of the mouse or the like. In other words, the pointer positional information is included in the learning operation information on the basis of the operation of the operating portion 45A (45B) in response to the learning information displayed on the display portion 44A (44B). Further, the pointer positional information corresponds to the positional information in response to the window displaying the learning information, as mentioned above and, for example, indicates what position in the window displayed in a predetermined size it is. In the case that this process is finished, the process is transferred to a step S123 (step S323).

Next, there is executed a decision and cancellation detecting process (step S123, and step S323). In this process, the CPU 42A (42B) collects the decision information and the cancellation information indicating the decision and the cancellation of the mouse or the like. In other words, the decision information and the cancellation information are included in the learning operation information on the basis of the operation of the operating portion 45A (45B) in response to the learning information displayed on the display portion 44A (44B). In the case that this process is finished, the process is transferred to a step S124 (step S324).

Next, there is executed a learning operation information generating process (step S124, and step S324). In this process, the CPU 42A (42B) generates the learning operation information on the basis of the character information, the pointer positional information, the decision information, and the cancellation information which are collected by the step S121 to the step S123 (step S321 to step S323), and stores in the memory 43A (43B). Accordingly, the CPU 42A (42B) sequentially collects the learning operation information on the basis of the operation of the operating portion 45A (45B) and in response to the learning information displayed on the display portion 44A (44B). In the case that this process is finished, the present sub-routine is finished.

[Transmitting Process]

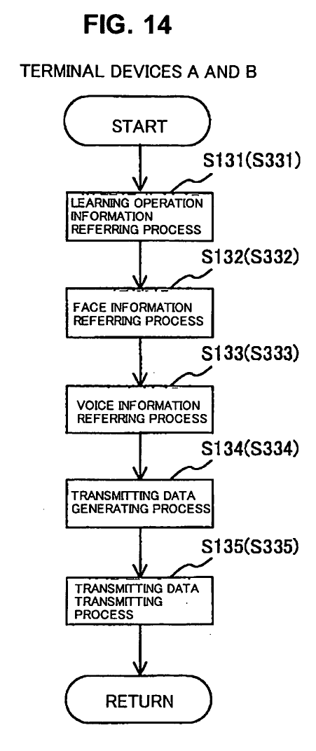

In the process of the step S111 (step S312) in the terminal device 41A (41B) shown in FIG. 12, a sub-routine shown in FIG. 14 is called.

In the transmitting process shown in FIG. 14, there is first executed a learning operation information referring process (step S131, and step S331). In this process, the CPU 42A (42B) refers to the learning operation information stored in the memory 43A (43B) in the step S124 (step S324). In the case that this process is finished, the process is transferred to a step S132 (step S332).

Next, there is executed a face image information referring process (step S132, and step S332). In this process, the CPU 42A (42B) refers to the face images of the student and the instructor stored in the memory 43A (43B) in the step S107 (step S308). In the case that this process is finished, the process is transferred to a step S133 (step S333).

Next, there is executed a voice information referring process (step S133, and step S333). In this process, the CPU 42A (42B) refers to the voices of the student and the instructor collected and stored in the memory 43A (43B) in the step S108 (step S309). In the case that this process is finished, the process is transferred to a step S134 (step S334).

Next, there is executed a transmitting data generating process (step S134, and step S334). In this process, the CPU 42A (42B) generates the data for transmission on the basis of the learning operation information, the face images of the student and the instructor and the voices thereof which are referred in the step S131 to the step S133. In the case that this process is finished, the process is transferred to a step S135 (step S335).

Next, there is executed a transmitting data transmitting process (step S135, and step S335). In this process, the CPU 42A (42B) transmits the data for transmission generated in the step S134 (step S334) to the learning server 21. Accordingly, the CPU 42A (42B) sequentially transmits the learning operation information and the like to the learning server 21. Further, as mentioned above, the information mentioned above is sequentially transmitted to the mutual terminal devices by the learning server 21. Accordingly, the CPU 42A (42B) sequentially transmits the learning operation information and the like to the terminal devices 41B (41A). In the case that this process is finished, the present sub-routine is finished.

Since the structure is made such as to collect and transmit the learning operation information on the basis of the operation of the operating portion in response to the learning information displayed on the display portion of the student terminal sequentially (in real time), and sequentially display the image relating to the learning operation information on the basis of the operation on the display portion of the instructor terminal, in accordance with the operation of the learning system as mentioned above, it is possible to display the learning condition such as the response of the learning information by the student to the instructor in detail and sequentially, so that it is possible to supply the useful information capable of supplying the high-quality learning information to the student.

Of course, a retention of the student utilizing the present system, the present server and the present program is increased by supplying the useful information capable of supplying the high-quality learning information to the student.

Further, it is possible to supply the learning environment taking an environment into consideration without using any unnecessary paper medium such as a test paper, a check list or the like. Of course, it is possible to mutually supply the information between both the terminals, and a simple structure is achieved.

In this case, “learning” simply allows the student to learn, is not limited to the learning in schools such as a school, a preparatory school, a professional school and the like, but corresponds to various aspects, for example, a self-education in a company, an audio conferencing system and the like.

Further, since the structure is made such as to sequentially collect and transmit the face information of the student and the voice information generated by the student, sequentially display the image relating to the transmitted face information on the display portion of the instructor terminal, and generate the transmitted voice information by the voice generating means of the instructor terminal, it is possible to display as an image and generate as a voice the learning condition such as a facial expression, a voice tone and the like of the student in detail and sequentially to the instructor, whereby it is possible to supply a further useful information capable of providing the high-quality learning information to the student.

Further, the structure may be made such that “the display control means in the instructor terminal has a function of displaying the face information and the learning operation information in parallel (simultaneously) on the display portion”. Of course, the structure may be made such that “the voice generating means in the instructor has a function of generating a voice information in parallel to displaying the face information and the learning operation information on the display portion by the display control means in the instructor terminal”, whereby it is possible to supply a useful information to the instructor at a distance.

Further, the structure may be made such that “the instructor terminal has a photographing means for sequentially photographing a face information of the instructor, a voice collecting means for sequentially collecting a voice information generated by the instructor, and a transmitting means for transmitting the face information sequentially photographed by the photographing means and the voice information sequentially collected by the voice collecting means to the student terminal”, and the structure may be made such that “the student terminal has a display control means for sequentially displaying the face information transmitted by the transmitting means in the instructor terminal on the display portion, and a voice generating means for generating a voice information transmitted by the transmitting means in the instructor terminal”.

In accordance with the structure mentioned above, it is possible to display as the image and generate as the voice the learning condition such as the facial expression, the voice tone or the like of the instructor in detail and sequentially to the student, and it is possible to supply the further useful information capable of providing the high-quality learning information and learning environment to the student.

In this case, the transmitting means of the student terminal and the instructor terminal may be separately structured such as a first transmitting means for transmitting the face image, a second transmitting means for transmitting the voice information, and a third transmitting means for transmitting the learning information. Of course, the transmitting means of the instructor terminal may be separately structured such as a first transmitting means for transmitting the face information, a second transmitting means for transmitting the voice information, and a third transmitting means for transmitting the question information.

Further, since the structure is made such that the question information is transmitted, and the learning operation information in response to the question information is displayed on the display portion of the instructor terminal, it is possible to transmit the information for making the response or the like of the learning of the student corresponding to the learning operation information in response to the question information more definite to the student terminal, and the learning operation information is displayed on the display portion of the instructor terminal. Therefore, it is possible to supply the further useful information capable of providing the high-quality learning information to the student.

Further, it is possible to determine whether effective or ineffective the various transmitting functions are, by the student, it is possible to supply the learning environment desired by the student, and a simple and convenient structure is achieved. Of course, the structure may be made such that “the instructor terminal has a selecting means for selecting whether making the function of transmitting the learning operation information by the transmitting means effective or ineffective, on the basis of the operation of the operating portion”, and the student terminal and the instructor terminal may be combined.

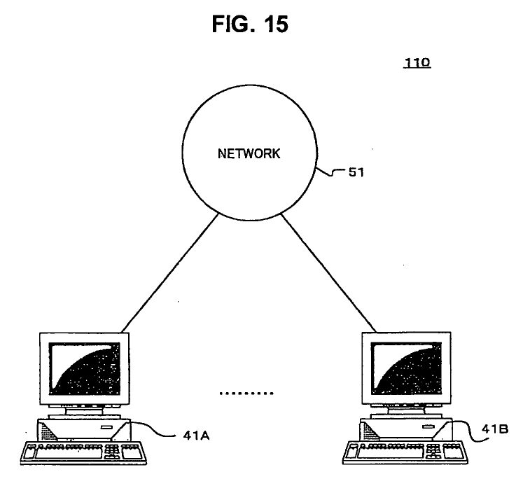

Further, in the present embodiment, the structure is made such as to be provided with the learning server 21 having the various functions mentioned above, however, the structure is not limited to this, but may employ the other aspects. For example, as shown in FIG. 15, the structure may be made such as to be provided with no learning server 21. In this case, the structure is preferably made such that at least a part of the functions of the learning server 21 mentioned above is provided in the instructor terminal (for example, the terminal device 41B) operable by the instructor.

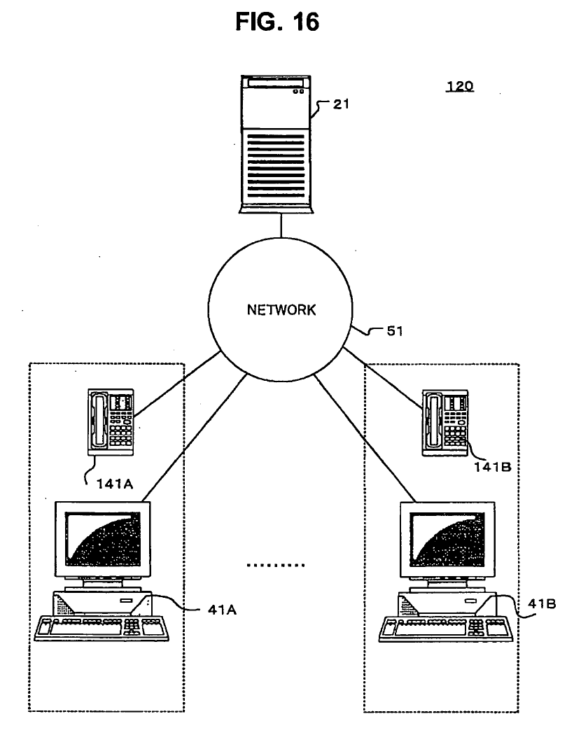

Further, a plurality of telephone sets 141A, 141B, . . . serving as the voice generating portion 49 can be connected to the network 51 in correspondence to a plurality of terminal devices 41A, 41B, . . . , as shown in FIG. 16, and a plurality of the telephone sets 141A, 141B, . . . can be called with each other via the network 51.

Accordingly, the voice information relating to the learning can be transmitted and received between the student learning by utilizing the present learning server 21 and the terminal device 41A, and the learning provider instructing the student by utilizing the present learning server 21 and the terminal device 41B, or between the student learning by utilizing the present learning server 21 and the terminal device 41A, and the student learning by utilizing the present learning server 21 and the terminal device 41B, and it is possible to expect an improvement of intelligibility and retention with respect to the learning.

The description is given above of the embodiment in accordance with the present invention, however, the embodiment is shown only as a concrete example, and does not limit the present invention. In other words, in accordance with the present invention, there is mainly provided with a learning system connecting a student terminal having an operating portion capable of being operated by a student, a display portion on which an image visible by the student is displayed, and a display control means for displaying the image on the display portion, to an instructor terminal having a display portion for displaying an image visible by an instructor, and a display control means for displaying the image on the display portion, so as to freely communicate, and transmitting and receiving a learning information relating to a learning between the student terminal and the instructor terminal, wherein the student terminal has a learning operation information collecting means for sequentially collecting a learning operation information on the basis of an operation of the operating portion in response to the learning information displayed on the display portion, and a transmitting means for sequentially transmitting the learning operation information to the instructor terminal, and the display control means in the instructor terminal has a function of sequentially displaying the image relating to the learning operation information on the display portion. However, it is possible to appropriately change the design of the concrete structures of the learning server, the student terminal, the instructor terminal, the operating portion, the display portion, the display control means, the learning operation information collecting means, the transmitting means, the voice generating means, the photographing means, the voice collecting means, the question information memory means, the selecting means, the learning memory means and the like.

[Real Time System Flow]

Next, a description will be given of a flow of a system by which the display control means in the instructor terminal and the student terminal display the images relating to the learning operation information and the instructing operation information on the display portion sequentially in real time.

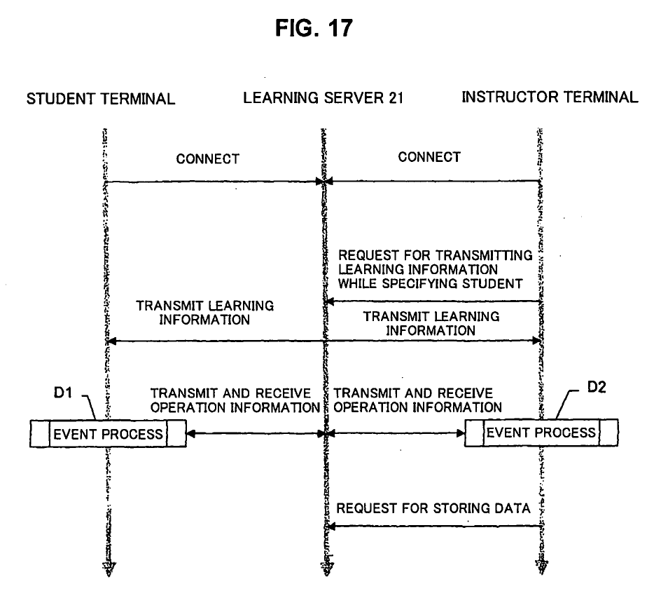

FIG. 17 is a view showing an outline of the processing procedure of each of the terminals in the real time learning system.

In this case, it is possible to classify the aspect of the real time connection in the learning system in accordance with an embodiment of the present invention into three kinds. In particular, one is a method (1-way method) in which one instructor terminal and one student terminal are connected, and the learning operation information of the student is displayed on the instructor terminal. Further, one is a method (2-way method) in which one instructor terminal and one student terminal are connected, and both of the terminals display both of the operation information (the learning operation information and the instructing operation information). Further, one is a method (n-way method) in which one instructor terminal and a plurality of student terminals are connected, and the operation information (the learning operation information and the instructing operation information) of the other terminals is displayed among the terminals.

In each of the methods, the procedures for connection the learning server 21, displaying of the learning operation information and the instructing operation information and storing of the result are as shown in FIG. 17, and are not different, but only a procedure of an event process in each of the terminals is different.

In FIG. 17, there is executed connection to the learning server 21 from the instructor terminal on the basis of connection to the learning server 21 from the student terminal. The student executes the connection to the learning server 21 on a previously specified date and time, or informs to the instructor of the connection by telephone, or the connection is automatically informed to the instructor.

Further, on the basis of the connection from the student, the instructor specifies the student in the instructor terminal and makes a request for transmitting the learning information to the learning server 21. The learning server 21 can transmit the learning information to the student terminal and/or the instructor terminal by doing so.

The student terminal and the instructor terminal receiving the learning information start the event process on the basis of the learning information. In the course of the event process, the operation information of the student terminal and/or the instructor terminal is transmitted to and received from the learning server 21.

Further, when the event process is finished, it is requested by the operation in the instructor terminal side to store the learning operation information temporarily stored in the learning server 21.

[1-Way Method]

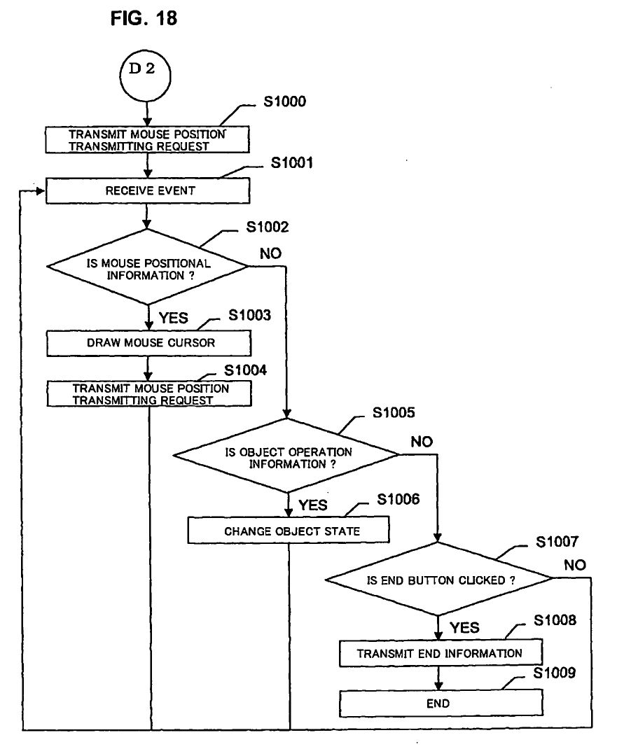

FIG. 18 is a view showing the event processing procedure in accordance with the 1-way method, and particularly shows a flow in the instructor terminal.

As the event process in accordance with the 1-way method in the instructor terminal side, a mouse position transmitting request is first transmitted to the learning server 21 (step S1000). This corresponds to a process of transmitting the learning operation information such as the mouse position or the like of the student terminal to the instructor terminal, for displaying the mouse position in the student terminal on the instructor terminal via the learning sever 21.

Next, the event is received (step S1001), and it is judged whether or not the information transmitted from the student terminal corresponds to the mouse positional information (step S1002). In this case, if it is determined that the information corresponds to the mouse positional information, a mouse cursor of the student terminal is drawn on the instructor terminal in a simulating manner (step S1003). In the instructor terminal, the mouse position transmitting request is again transmitted for to repeatedly executing the processes of the steps S1001 to S1003 (step S1004).

On the other hand, if it is determined in the step S1002 that the information does not correspond to the mouse positional information, it is judged whether or not the information transmitted from the student terminal corresponds to an object operation information (step S1005). In this case, if it is determined that the information corresponds to the object operation information, the object state changed in the student terminal is also changed in the instructor terminal (step S1006). In the instructor terminal, the processes of the steps S1001 to S1006 are repeatedly executed.

On the other hand, if it is determined in the step S1005 that the information does not correspond to the object operation information, it is next judged whether or not an end button is clicked (step S1007). In this case, if it is determined that the end button is clicked, an end information is transmitted to the learning server 21 (step S1008), and finishes the present sub-routine (step S1009).

On the other hand, if it is determined in the step S1007 that the end button is not clicked, the procedure goes back to the step S1001, and the processes are executed repeatedly.

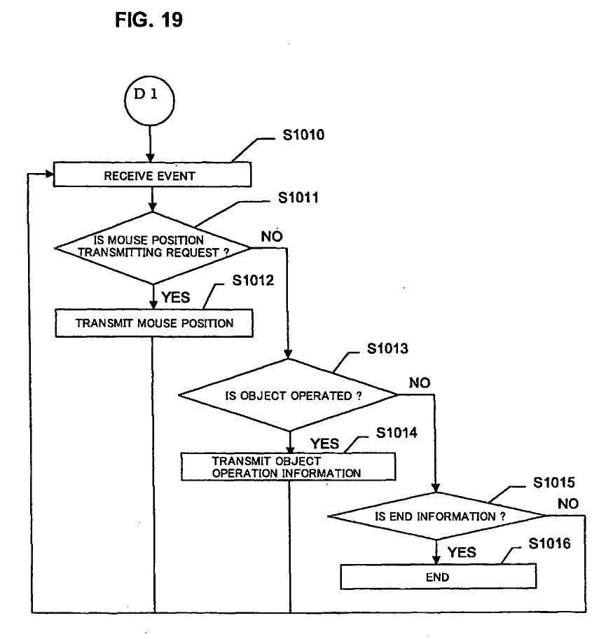

FIG. 19 is a view showing the event processing. procedure in accordance with the 1-way method, and particularly shows a flow in the student terminal.

As the event process in accordance with the 1-way method in the student terminal side, the event is first received (step S1010), and it is judged whether or not the transmitting request of the mouse positional information exists (step S1011). In this case, if it is determined that the transmitting request of the mouse positional information exists, the positional information of the mouse cursor of the student terminal is transmitted to the learning server 21 (step S1012). In the student terminal, the processes of the steps S1010 to S1012 are executed repeatedly.

On the other hand, if it is determined in the step S1011 that the transmitting request of the mouse positional information does not exist, it is next judged whether or not the object is operated (step S1013). In this case, if it is determined that the object is operated, the object operation information of the object changed in the student terminal is transmitted to the learning sever 21 (step S1014). In the student terminal, the processes of the steps S1010 to S1014 are repeatedly executed.

On the other hand, if it is determined in the step S1013 that the object is not operated, it is next judged whether or not the end button is clicked in the student terminal and the end information is output (step S1015). In this case, if it is determined that the end button is clicked, the end information is transmitted to the learning server 21, and the present sub-routine is finished (step S1016).

On the other hand, if it is determined in the step S1007 that the end button is not clicked, the procedure goes back to the step S1010, and the processes are executed repeatedly.

In this case, in the 1-way method in FIGS. 18 and 19, in the case that the mouse positional information is not transmitted and received, it is unnecessary to transmit and receive the mouse position transmitting request (steps S1000, S1004 and S1012), and the processes following thereto are not necessary. In this case, after receiving the event (S1001, and S1010), the information relating to the object is transmitted and received (step S1005, and step S1013).

[2-Way Method]

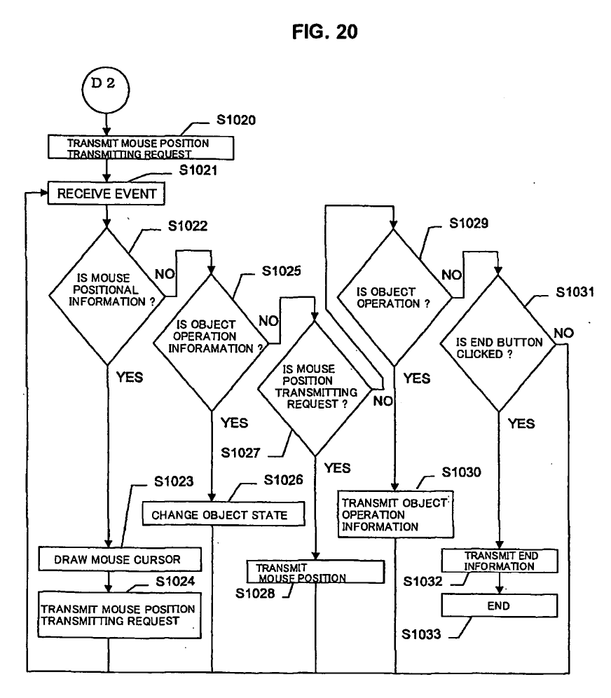

FIG. 20 is a view showing the event processing procedure in accordance with the 2-way method, and particularly shows a flow in the instructor terminal.

As the event process in accordance with the 2-way method in the instructor terminal side, a mouse position transmitting request is first transmitted to the learning server 21 (step S1020). This corresponds to a process of transmitting the learning operation information such as the mouse position or the like of the student terminal to the instructor terminal, for displaying the mouse position in the student terminal on the instructor terminal via the learning sever 21.

Next, the event is received (step S1021), and it is judged whether or not the information corresponds to the mouse positional information (step S1022). In this case, if it is determined that the information corresponds to the mouse positional information, a mouse cursor of the student terminal is drawn on the instructor terminal in a simulating manner (step S1023). In the instructor terminal, the mouse position transmitting request is again transmitted for repeatedly executing the processes of the steps S1001 to S1003 (step S1024).

On the other hand, if it is determined in the step S1022 that the information does not correspond to the mouse positional information, it is judged whether or not the information corresponds to an object operation information (step S1025). In this case, if it is determined that the information corresponds to the object operation information, the object state changed in the student terminal is also changed in the instructor terminal (step S1026). In the instructor terminal, the processes of the steps S1021 to S1026 are repeatedly executed.

On the other hand, if it is determined in the step S1025 that the information does not correspond to the object operation information, it is judged whether or not the information corresponds to the mouse position transmitting request (step S1027). This is for judging whether or not the request for transmitting the mouse position of the instructor terminal is output from the student terminal. If it is determined that the information corresponds to the mouse position transmitting request, the mouse positional information of the instructor terminal is transmitted to the student terminal via the learning server 21, and the mouse cursor is drawn on the student terminal in a simulating manner. In the instructor terminal, the processes of the steps S1021 to S1028 are repeatedly executed.

On the other hand, if it is determined in the step S1027 that the information does not correspond to the mouse position transmitting request, it is judged whether or not the information corresponds to the object operation (step S1029). This is for judging whether or not the request for transmitting the object operation of the instructor terminal is output from the student terminal. If it is determined that the information corresponds to the object operation, the object operation information of the instructor terminal is transmitted to the student terminal via the learning server 21, and the object operation is drawn on the student terminal in a simulating manner. In the instructor terminal, the processes of the steps S1021 to S1030 are repeatedly executed.

On the other hand, if it is determined in the step S1029 that the information does not correspond to the object operation, it is next judged whether or not the end button is clicked in the student terminal (step S1031). In this case, if it is determined that the end button is clicked, the end information is transmitted to the learning server 21 (step S1032), and the present sub-routine is finished (step S1033).

On the other hand, if it is determined in the step S1031 that the end button is not clicked, the procedure goes back to the step S1021, and the processes are executed repeatedly.

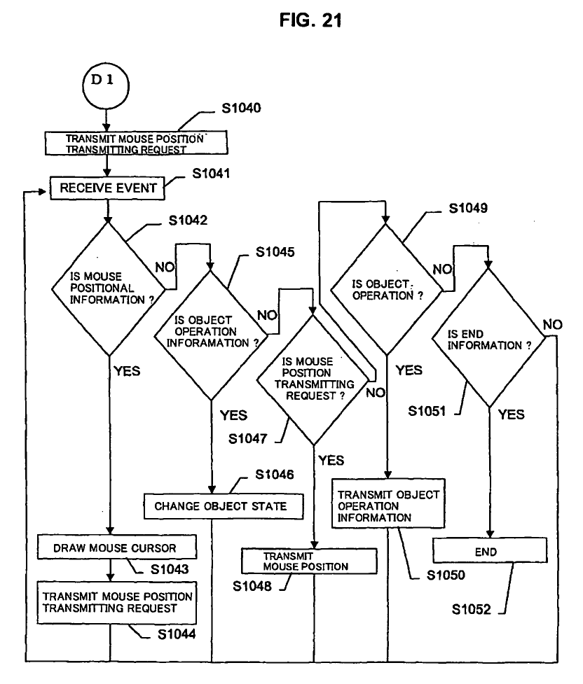

FIG. 21 is a view showing the event processing procedure in accordance with the 2-way method, and particularly shows a flow in the student terminal.

As the event process in accordance with the 2-way method in the student terminal side, a mouse position transmitting request is first transmitted to the learning server 21 (step S1040). This corresponds to a process of transmitting the learning operation information such as the mouse position or the like of the instructor terminal to the student terminal, for displaying the mouse position in the instructor terminal on the student terminal via the learning sever 21.

Next, the event is received (step S1041), and it is judged whether or not the information corresponds to the mouse positional information of the event (step S1042). In this case, if it is determined that the information corresponds to the mouse positional information, a mouse cursor of the instructor terminal is drawn on the student terminal in a simulating manner (step S1043). In the student terminal, the mouse position transmitting request is again transmitted for repeatedly executing the processes of the steps S1041 to S1044 (step S1044).

On the other hand, if it is determined in the step S1042 that the information does not correspond to the mouse positional information, it is judged whether or not the information corresponds to an object operation information (step S1045). In this case, if it is determined that the information corresponds to the object operation information, the object operation information changed in the instructor terminal is received and the object state in the student terminal is changed(step S1046). In the student terminal, the processes of the steps S1041 to S1046 are repeatedly executed.

On the other hand, if it is determined in the step S1045 that the information does not correspond to the object operation information, it is next judged whether or not the transmitting request exists in the mouse positional information of the event (step S1047). In this case, if it is determined that the transmitting request of the mouse positional information exists, the positional information of the mouse cursor of the student terminal is transmitted to the learning server 21 (step S1048). In the student terminal, the processes of the steps S1041 to S1048 are repeatedly executed.

On the other hand, if it is determined in the step S1047 that the transmitting request does not exists in the mouse positional information, it is next judged whether or not the object is operated (step S1049). In this case, if it is determined that the object is operated, the object operation information of the object changed in the student terminal is transmitted to the learning server 21 (step S1050). In the student terminal, the processes of the steps S1041 to S1050 are repeatedly executed.

On the other hand, if it is determined in the step S1049 that the object is not operated, it is next judged whether or not the end button is clicked and the end information is output (step S1051). In this case, if it is determined that the end button is clicked, the end information is transmitted to the learning server 21, and the present sub-routine is finished (step S1052).

On the other hand, if it is determined in the step S1051 that the end button is not clicked, the procedure goes back to the step S1041, and the processes are executed repeatedly.

As mentioned above, in the event processing procedure in accordance with the 2-way method, it is possible to transmit the information relating to the mouse position and the object operation in the instructor terminal to the student terminal via the learning server 21 so as to draw (display) in the student terminal in a simulating manner, and it is possible to transmit the information relating to the mouse position and the object operation in the student terminal to the instructor terminal via the learning server 21 so as to draw (display) in the instructor terminal in a simulating manner.

In this case, in accordance with the 2-way method in FIGS. 20 and 21, in the case that the mouse positional information is neither transmitted nor received, it is unnecessary to transmit and receive the mouse position transmitting request (steps S1020, S1024, S1040 and S1044), and the processes incidental thereto are not necessary. In this case, after receipt of the event (S1021, and S1041), the information relating to the object is transmitted and received (steps S1025, and step S1045).

[N-Way Method]

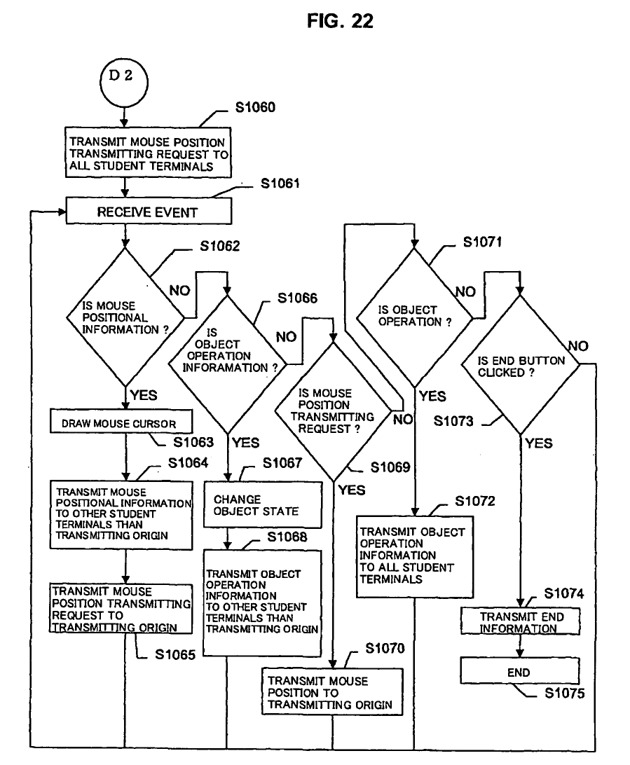

FIG. 22 is a view showing the event processing procedure in accordance with the n-way method, and particularly shows a flow in the instructor terminal.

As the event process in accordance with the n-way method in the instructor terminal side, a mouse position transmitting request is first transmitted to all the student terminals via the learning server 21 (step S1060). This corresponds to a process of transmitting the learning operation information such as the mouse positions or the like of all the student terminals to the instructor terminal, for displaying the mouse positions in all the student terminals on the instructor terminal via the learning sever 21.

Next, the event is received (step S1061), and it is judged whether or not the information corresponds to the mouse positional information at a time when the mouse position is changed in one student terminal (step S1062). In this case, if it is determined that the information corresponds to the mouse positional information, a mouse cursor of the one student terminal on is drawn the instructor terminal in a simulating manner (step S1023). In conjunction therewith, the mouse positional information is transmitted to the other student terminals than the one student terminal (the transmitting origin) (step S1064). In the instructor terminal, the mouse position transmitting request is again transmitted to the one student terminal (the transmitting origin) for repeatedly executing the processes of the steps S1061 to S1065 (step S1065).

On the other hand, if it is determined in the step S1062 that the information does not correspond to the mouse positional information, it is judged whether or not the information corresponds to an object operation information (step S1066). In this case, if it is determined that the information corresponds to the object operation information, the object state changed in the one student terminal is changed also in the instructor terminal (step S1067). In conjunction therewith, the object operation information is transmitted to the other student terminals than the one student terminal (the transmitting origin) (step S1064). In the instructor terminal, the processes of the steps S1061 to S1068 are repeatedly executed.

On the other hand, if it is determined in the step S1066 that the information does not correspond to the object operation information, it is judged whether or not the information corresponds to the mouse position transmitting request (step S1069). This is for judging whether or not the request for transmitting the mouse position of the instructor terminal is output from the one student terminal. If it is determined that the information corresponds to the mouse position transmitting request, the mouse positional information of the instructor terminal is transmitted to the one student terminal (the transmitting origin) via the learning server 21, and the mouse cursor is drawn on the one student terminal in a simulating manner. In the instructor terminal, the processes of the steps S1061 to S1070 are repeatedly executed.

On the other hand, if it is determined in the step S1069 that the information does not correspond to the mouse position transmitting request, it is judged whether or not the information corresponds to the object operation (step S1071). This corresponds to a process for transmitting the object operation executed in the instructor terminal to all the student terminals. If it is determined that the information corresponds to the object operation, the object operation information of the instructor terminal is transmitted to all the student terminal via the learning server 21, and the object operation is drawn on all the student terminal in a simulating manner. In the instructor terminal, the processes of the steps S1061 to S1072 are repeatedly executed.

On the other hand, if it is determined in the step S1071 that the information does not correspond to the object operation, it is next judged whether or not the end button is clicked (step S1073). In this case, if it is determined that the end button is clicked, the end information is transmitted to the learning server 21 (step S1074), and the present sub-routine is finished (step S1075).

On the other hand, if it is determined in the step S1073 that the end button is not clicked, the procedure goes back to the step S1061, and the processes are executed repeatedly.

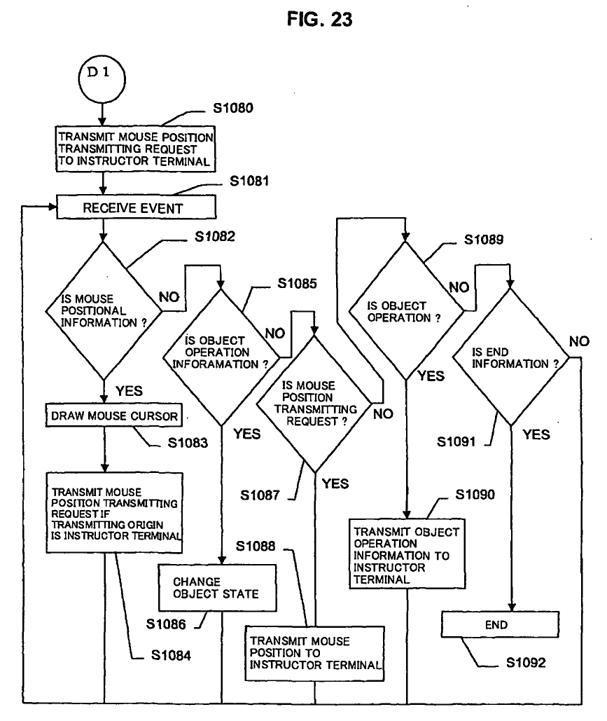

FIG. 23 is a view showing the event processing procedure in accordance with the n-way method, and particularly shows a flow in the student terminal.

As the event process in accordance with the n-way method in the student terminal side, a mouse position transmitting request is first transmitted to the learning server 21 (step S1080). This corresponds to a process of transmitting the learning operation information such as the mouse position or the like of the instructor terminal to the student terminal, for displaying the mouse position in the instructor terminal on the student terminal via the learning sever 21.

Next, the event is received (step S1081), and it is judged whether or not the information corresponds to the mouse positional information of the event (step S1082). In this case, if it is determined that the information corresponds to the mouse positional information, a mouse cursor of the instructor terminal is drawn on the student terminal in a simulating manner (step S1083). If the mouse positional information is output from the instructor terminal, the mouse position transmitting request is again transmitted for transmitting the learning operation information such as the mouse position of the instructor terminal and the like to the student terminal (step S1084). In the student terminal, the processes of the steps S1081 to S1084 are repeatedly executed.

On the other hand, if it is determined in the step S1082 that the information does not correspond to the mouse positional information, it is judged whether or not the information corresponds to an object operation information (step S1085). In this case, if it is determined that the information corresponds to the object operation information, the object operation information changed in the instructor terminal is received and the object state in the student terminal is changed (step S1086). In the student terminal, the processes of the steps S1081 to S1086 are repeatedly executed.

On the other hand, if it is determined in the step S1085 that the information does not correspond to the object operation information, it is next judged whether or not the transmitting request exists in the mouse positional information of the event (step S1087). In this case, if it is determined that the transmitting request of the mouse positional information exists, the positional information of the mouse cursor of the student terminal is transmitted to the learning server 21 (step S1088). In the student terminal, the processes of the steps S1081 to S1088 are repeatedly executed.

On the other hand, if it is determined in the step S1087 that the transmitting request does not exists in the mouse positional information, it is next judged whether or not the object is operated (step S1089). In this case, if it is determined that the object is operated, the object operation information of the object changed in the student terminal is transmitted to the instructor terminal via the learning server 21 (step S1090). In the student terminal, the processes of the steps S1081 to S1090 are repeatedly executed.

On the other hand, if it is determined in the step S1089 that the object is not operated, it is next judged whether or not the end button is clicked and the end information is output (step S1091). In this case, if it is determined that the end button is clicked, the end information is transmitted to the learning server 21, and the present sub-routine is finished (step S1092).

On the other hand, if it is determined in the step S1091 that the end button is not clicked, the procedure goes back to the step S1041, and the processes are executed repeatedly.

As mentioned above, in the event processing procedure in accordance with the n-way method, it is possible to transmit the information relating to the mouse position and the object operation in the instructor terminal to the student terminal via the learning server 21 so as to draw (display) in the student terminal in a simulating manner, and it is possible to transmit the information relating to the mouse position and the object operation in the student terminal to the instructor terminal via the learning server 21 so as to draw (display) in the instructor terminal in a simulating manner. Further, the learning operation information in the one student terminal is also transmitted to the other student terminals, and the learning operation of the one student terminal can be displayed also on the other student terminals.

In this case, in accordance with the n-way method in FIGS. 22 and 23, in the case that the mouse positional information is neither transmitted nor received, it is unnecessary to transmit and receive the mouse position transmitting request (steps S1060, S1064, S1065, S1069, S1080, S1084, S1087 and S1088), and the processes incidental thereto are not necessary. In this case, after receipt of the event (S1061 and S1081), the information-relating to the object is transmitted and received (steps S1066 and S1085). Further, in the steps S1064 and S1068, it is possible to suppress a latency (a delay after the operation is executed on the terminal until it is reflected on the other terminals) by executing these processes in the learning server 21 and the other servers instead of executing these processes in the instructor terminal.

The effects described in the embodiment in accordance with the present invention are only the most preferable effects generated from the present invention, and the effect achieved by the present invention is not limited to the effects described in the embodiment in accordance with the present invention.

1-17. (canceled)

18. A learning system connecting a student terminal having an operating portion capable of being operated by a student, a display portion on which an image visible by the student is displayed, and a display control means for displaying the image on the display portion, to an instructor terminal having a display portion displaying an image visible by an instructor, and a display control means for displaying an image on the display portion, so as to freely communicate, and transmitting and receiving learning information relating to a learning between the student terminal and the instructor terminal, wherein the student terminal has a learning operation information collecting means for sequentially collecting learning operation information on the basis of operation of the operating portion in correspondence to the learning information displayed on the display portion of the student terminal, and a transmitting means for sequentially transmitting the learning operation information to the instructor terminal, and the display control means in the instructor terminal has a function of sequentially displaying the image relating to the learning operation information on the display portion of the instructor terminal.

19. A learning system connecting a student terminal having an operating portion capable of being operated by a student, a display portion on which an image visible by the student is displayed, and a display control means for displaying the image on the display portion, to an instructor terminal having a display portion displaying an image visible by an instructor, a display control means for displaying an image on the display portion, and a voice generating means for generating a voice, so as to freely communicate, and transmitting and receiving learning information relating to a learning between the student terminal and the instructor terminal, wherein the student terminal has a learning operation information collecting means for sequentially collecting a learning operation information on the basis of an operation of the operating portion in correspondence to the learning information displayed on the display portion of the student terminal, a photographing means for sequentially photographing face information of the student, a voice collecting means for sequentially collecting voice information generated by the student, and a transmitting means for sequentially transmitting the face information, the learning operation information and the voice information to the instructor terminal, the display control means in the instructor terminal has a function of sequentially displaying the image relating to the face information and the learning operation information on the display portion of the instructor terminal, and the voice generating means in the instructor terminal has a function of generating the voice information.

20. A learning system connecting an instructor terminal having an operating portion capable of being operated by an instructor, a display portion on which an image visible by the instructor is displayed, and a display control means for displaying an image on the display portion, to a student terminal having a display portion displaying an image visible by a student, and a display control means for displaying the image on the display portion, so as to freely communicate, and transmitting and receiving learning information relating to a learning between the student terminal and the instructor terminal, wherein the instructor terminal has an instructor operation information collecting means for sequentially collecting instructor operation information on the basis of operation of the operating portion, and a transmitting means for sequentially transmitting the instructor operation information to the student terminal, and the display control means in the student terminal has a function of sequentially displaying the image relating to the instructor operation information on the display portion of the student terminal.

21. A learning system connecting a student terminal having an operating portion capable of being operated by a student, a display portion on which an image visible by the student is displayed, and a display control means for displaying the image on the display portion, to an instructor terminal having a display portion displaying an image visible by an instructor, and a display control means for displaying an image on the display portion, so as to freely communicate, and transmitting and receiving learning information relating to a learning between the student terminal and the instructor terminal, wherein the instructor terminal and another of the student terminal has a learning operation information collecting means for sequentially collecting learning operation information on the basis of an operation of the operating portion of one of the student terminal, and a transmitting means for sequentially transmitting the learning operation information to the instructor terminal and the other of the student terminal, and the display control means in the other student terminal and the instructor terminal have a function of sequentially displaying the image relating to the learning operation information on the display portions of the other student terminal and the instructor terminal.

22. A learning system connecting an instructor terminal having an operating portion capable of being operated by an instructor, a display portion on which an image visible by the instructor is displayed, and a display control means for displaying an image on the display portion, to a student terminal having an operating portion capable of being operated by a student, a display portion displaying an image visible by the student, and a display control means for displaying the image on the display portion, so as to freely communicate, and transmitting and receiving learning information relating to a learning between the student terminal and the instructor terminal, wherein the student terminal has a learning operation information collecting means for sequentially collecting learning operation information on the basis of operation of the operating portion in correspondence to the learning information displayed on the display portion of the student terminal, and a transmitting means for sequentially transmitting the learning operation information to the instructor terminal, the display control means in the instructor terminal has a function of sequentially displaying the image relating to the learning operation information on the display portion of the instructor terminal, the instructor terminal has an instructor operation information collecting means for sequentially collecting an instructor operation information on the basis of operation of the operating portion, and a transmitting means for sequentially transmitting the instructor operation information to the student terminal, and the display control means in the student terminal has a function of sequentially displaying the image relating to the instructor operation information on the display portion of the student terminal.

23. A learning system as claimed in claim 18, wherein the instructor terminal has a transmitting means for transmitting question information relating to the learning to the student terminal, and the learning operation information collecting means in the student terminal has a function of sequentially collecting the learning operation information on the basis of the operation of the operating portion in correspondence to the question information displayed on the display portion of the student terminal.

24. A learning system as claimed in claim 19, wherein the instructor terminal has a transmitting means for transmitting question information relating to the learning to the student terminal, and the learning operation information collecting means in the student terminal has a function of sequentially collecting the learning operation information on the basis of the operation of the operating portion in correspondence to the question information displayed on the display portion of the student terminal.

25. A learning system as claimed in claim 20, wherein the instructor terminal has a transmitting means for transmitting question information relating to the learning to the student terminal, and the learning operation information collecting means in the student terminal has a function of sequentially collecting the learning operation information on the basis of the operation of the operating portion in correspondence to the question information displayed on the display portion of the student terminal.

26. A learning system as claimed in claim 21, wherein the instructor terminal has a transmitting means for transmitting question information relating to the learning to the student terminal, and the learning operation information collecting means in the student terminal has a function of sequentially collecting the learning operation information on the basis of the operation of the operating portion in correspondence to the question information displayed on the display portion of the student terminal.

27. A learning system as claimed in claim 22, wherein the instructor terminal has a transmitting means for transmitting question information relating to the learning to the student terminal, and the learning operation information collecting means in the student terminal has a function of sequentially collecting the learning operation information on the basis of the operation of the operating portion in correspondence to the question information displayed on the display portion of the student terminal.

28. A learning system as claimed in claim 18, wherein the learning operation information collecting means in the student terminal has a function of sequentially collecting at least one of character information, positional information, decision information and cancellation information included in the learning operation information on the basis of the operation of the operating portion in correspondence to the learning information displayed on the display portion of the student terminal.

29. A learning system as claimed in claim 19, wherein the learning operation information collecting means in the student terminal has a function of sequentially collecting at least one of character information, positional information, decision information and cancellation information included in the learning operation information on the basis of the operation of the operating portion in correspondence to the learning information displayed on the display portion of the student terminal.

30. A learning system as claimed in claim 20, wherein the learning operation information collecting means in the student terminal has a function of sequentially collecting at least one of character information, positional information, decision information and cancellation information included in the learning operation information on the basis of the operation of the operating portion in correspondence to the learning information displayed on the display portion of the student terminal.

31. A learning system as claimed in claim 21, wherein the learning operation information collecting means in the student terminal has a function of sequentially collecting at least one of character information, positional information, decision information and cancellation information included in the learning operation information on the basis of the operation of the operating portion in correspondence to the learning information displayed on the display portion of the student terminal.

32. A learning system as claimed in claim 22, wherein the learning operation information collecting means in the student terminal has a function of sequentially collecting at least one of character information, positional information, decision information and cancellation information included in the learning operation information on the basis of the operation of the operating portion in correspondence to the learning information displayed on the display portion of the student terminal.

33. A learning system as claimed in claim 18, wherein the instructor terminal has a learning memory means for storing at least one of the learning operation information, the face information and the voice information transmitted from the transmitting means in the student terminal.

34. A learning system as claimed in claim 19, wherein the instructor terminal has a learning memory means for storing at least one of the learning operation information, the face information and the voice information transmitted from the transmitting means in the student terminal.

35. A learning system as claimed in claim 20, wherein the instructor terminal has a learning memory means for storing at least one of the learning operation information, the face information and the voice information transmitted from the transmitting means in the student terminal.

36. A learning system as claimed in claim 21, wherein the instructor terminal has a learning memory means for storing at least one of the learning operation information, the face information and the voice information transmitted from the transmitting means in the student terminal.

37. A learning system as claimed in claim 22, wherein the instructor terminal has a learning memory means for storing at least one of the learning operation information, the face information and the voice information transmitted from the transmitting means in the student terminal.

38. A learning system as claimed in claim 18, wherein the student terminal has a selecting means for selecting whether making the function of transmitting the learning operation information by the transmitting means effective or ineffective.

39. A learning system as claimed in claim 19, wherein the student terminal has a selecting means for selecting whether making the function of transmitting the learning operation information by the transmitting means effective or ineffective.

40. A learning system as claimed in claim 20, wherein the student terminal has a selecting means for selecting whether making the function of transmitting the learning operation information by the transmitting means effective or ineffective.

41. A learning system as claimed in claim 21, wherein the student terminal has a selecting means for selecting whether making the function of transmitting the learning operation information by the transmitting means effective or ineffective.

42. A learning system as claimed in claim 22, wherein the student terminal has a selecting means for selecting whether making the function of transmitting the learning operation information by the transmitting means effective or ineffective.

43. A learning server connected to a student terminal having an operating portion capable of being operated by a student, and a display portion on which an image visible by the student is displayed and an instructor terminal having a display portion on which an image visible by an instructor is displayed, so as to freely communicate, and transmitting and receiving learning information relating to a learning with respect to the student terminal and the instructor terminal, wherein the learning server has a transmitting means for sequentially transmitting a signal for sequentially displaying an image relating to learning operation information on the basis of operation of the operating portion on the display portion of the instructor terminal to the instructor terminal, in correspondence to the learning information sequentially transmitted from the student terminal and displayed on the display portion of the student terminal.

44. A learning server as claimed in claim 43, wherein the learning server has a question information memory means for storing question information relating to a learning, and the transmitting means has a function of transmitting the question information to the student terminal in correspondence to a question request signal from the instructor terminal, and has a function of sequentially transmitting a signal for sequentially displaying an image relating to the learning operation information on the basis of the operation of the operating portion on the display portion of the instructor terminal, to the instructor terminal, in correspondence to the question information sequentially transmitted from the student terminal and displayed on the display portion of the student terminal.

45. A learning server as claimed in claim 43, wherein the learning server has a transmitting means for sequentially transmitting a signal for sequentially displaying an image relating to at least one of character information, positional information of a pointer, decision information and cancellation information included in the learning operation information on the basis of the operation of the operating portion on the display portion of the instructor terminal, to the instructor terminal, in correspondence to the learning information sequentially transmitted from the student terminal and displayed on the display portion of the student terminal.

46. A learning server as claimed in claim 43, wherein the learning server has a billing means for billing with respect to the student terminal and/or the instructor terminal, in the case that the function in the transmitting means is made effective.

47. A learning server as claimed in claim 44, wherein the learning server has a billing means for billing with respect to the student terminal and/or the instructor terminal, in the case that the function in the transmitting means is made effective.

48. A learning server as claimed in claim 45, wherein the learning server has a billing means for billing with respect to the student terminal and/or the instructor terminal, in the case that the function in the transmitting means is made effective.

49. A program for making a student terminal having an operating portion capable of being operated by a student and a display portion on which an image visible by the student is displayed, function as a display step of displaying learning information relating to a learning on the display portion, a collecting step of sequentially collecting a learning operation information on the basis of operation of the operating portion, in correspondence to the learning information displayed on the display portion in accordance with the display step, and a transmitting step of sequentially transmitting a signal for displaying the learning operation information sequentially collected in accordance with the collecting step on a display portion in an instructor terminal connected so as to freely communicate, to the instructor terminal.

50. A program for making a student terminal having an operating portion capable of being operated by an instructor and a display portion on which an image visible by the instructor is displayed, function as a display step of displaying instruction information relating to an instruction on the display portion, a collecting step of sequentially collecting instruction operation information on the basis of operation of the operating portion, in correspondence to the instruction information displayed on the display portion in accordance with the display step, and a transmitting step of sequentially transmitting a signal for displaying the instruction operation information sequentially collected in accordance with the collecting step on a display portion in a student terminal connected so as to freely communicate, to the student terminal.

51. A program for making a student terminal having an operating portion capable of being operated by a student and a display portion on which an image visible by the student is displayed, function as a display step of displaying learning information relating to a learning on the display portion, a collecting step of sequentially collecting learning operation information on the basis of operation of the operating portion, in correspondence to the learning information displayed on the display portion in accordance with the display step, and a transmitting step of sequentially transmitting a signal for displaying the learning operation information sequentially collected in accordance with the collecting step on a display portion in another student terminal and an instructor terminal connected so as to freely communicate, to the other student terminal and the instructor terminal.
